(19) United States
(12) Patent Application Publication
(10) Pub. No.: US 2026/0144250 A1
(43) Pub. Date: May 28, 2026

(54) SOLVENT-FREE FORMULATIONS OF LOW-MELTING ACTIVE INGREDIENTS

(71) Applicant: Bayer CropScience Aktiengesellschaft, Monheim am Rhein (DE)

(72) Inventors: Jens Krause, Leverkusen (DE); Andreas Röchling, Langenfeld (DE); Joachim Krüger, Monheim (DE); Hans-Peter Krause, Hofheim (DE); Arno Ratschinski, Düsseldorf (DE)

(21) Appl. No.: 19/453,513

(22) Filed: Jan. 20, 2026

Related U.S. Application Data
(63) Continuation of application No. 16/079,856, now abandoned.

(30) Foreign Application Priority Data
Feb. 26, 2016 (EP) 16157517.0

(51) Int. Cl. A01N 25/04; A01N 25/14; A01N 25/32; A01N 47/36

(52) U.S. Cl. CPC A01N 25/04; A01N 25/14; A01N 25/32; A01N 47/36

(57) ABSTRACT

The present disclosure relates to solvent-free aqueous suspension concentrates and to solvent-free solid water-dispersible formulations comprising one or more low-melting active ingredients, and to processes for production thereof. The formulations according to the disclosure are suitable for the field of plant protection.

### CROSS-REFERENCE TO RELATED APPLICATIONS

This application is a Continuation Application of U.S. application Ser. No. 16/079,856, filed Aug. 24, 2018, which is a National stage entry of International Application No. PCT/EP2017/053987, filed Feb. 22, 2017, which claims priority to European Patent Application No. 16157517.0, filed Feb. 26, 2016.

The present disclosure relates to solvent-free aqueous suspension concentrates and to solvent-free solid water-dispersible formulations comprising one or more low-melting active ingredients, and to processes for production thereof. The formulations according to the disclosure are suitable for the field of plant protection.

### DESCRIPTION OF RELATED ART

Active ingredients can in principle be formulated in many different ways, and the properties of the active ingredients and the nature of the formulation can present problems in terms of producibility, stability, usability and efficacy of the formulations. Moreover, particular formulations are more advantageous than others for economic and environmental reasons.

Water-based formulations generally have the advantage of requiring a small proportion of organic solvents, if any.

On the other hand, there is generally a need for highly concentrated formulations of active ingredients because the higher concentration has many advantages. For example, with highly concentrated formulations, there is less need for packaging than with formulations of low concentration. There is a corresponding reduction in the expenditure on production, transport and storage. Furthermore, there is simplification, for example, of the preparation of the spray liquors used in agriculture through the smaller amounts of crop protection compositions, for example, which have to be handled, for example in the dispensing and mixing operation. Moreover, water-concentrated formulations are usually not just more highly concentrated than organic, solvent-containing formulations, but also environmentally desirable since they are free of solvents. Likewise of high concentration are water-dispersible granule formulations (WGs). Both water-dispersible granules and suspension concentrates (SCs) are therefore preferable from an economic and environmental point of view.

However, some substances, for instance herbicide safeners, cannot be added directly to water because of their low and broad melting range and their amorphous structure, and so they first have to be dissolved/formulated in organic solvents. In that case, they are formulated, for example, as organic dispersions, aqueous emulsion, suspoemulsion, capsule suspension or as emulsion concentrate, with the low-melting active ingredient in dissolved or emulsified form. A disadvantage here is that it is not possible here through the addition of organic solvents to obtain aqueous dispersion; instead, what are formed are aqueous emulsions or suspoemulsions, which are much less stable in storage and usually also of lower concentration than pure aqueous dispersions. In the processing of the technical concentrate to give water-dispersible granules, up to 20% by weight remains in the end product in the case of the mineral oils customarily used as solvent (for example Solvesso 200 ND from ExxonMobil).

In the case of the water-dispersible granules available on the market, quality impairments can arise. These include: inadequate dispersibility/suspendability, unacceptable sieve residues, inadequate free-flow/compaction of the bulk material, blockage of filters and nozzles, or persistent staining of spray equipment.

Overall, the liquid formulations known from the prior art which comprise mefenpyr-diethyl or cloquintocet-mexyl as herbicide safeners are emulsion concentrates or oil dispersions. Purely aqueous dispersions or granules of these herbicide safeners that result therefrom are unknown to date.

Specifically herbicide safeners (for example mefenpyr-diethyl or cloquintocet-mexyl) are often in the form of esterified acids which are available in their technical grade quality as a solidified melt with a melting range. Only conversion to a powder by purification with controlled crystallization would enable direct addition of the powder thus obtained to the aqueous phase. However, this purification is not just technically complex and costly; these particles are also only weakly stabilized in the course of grinding and therefore have a tendency to stick on grinding.

The prior art discloses relatively highly concentrated aqueous suspension concentrates, for example of sulphur (EP-A-0220655) and metamitron (EP-A-0620971), or mixtures of formaldehyde condensation products, preferably lignosulphonates and wetting agents.

WO-A 91/07874 discloses mefenpyr-diethyl-containing formulations. However, the aqueous dispersion concentrates specified therein contain organic solvent in an amount of 77% by weight, and so they are suspoemulsions.

U.S. Pat. No. 5,785,976 and WO-A 03/034822 describe melt dispersions, but the substances here are in an amorphous state on the nanometre scale. The pre-concentrates are cooled here in a shock-like manner, and so there is no controlled, homogeneously crystalline dispersion. Grinding with further dispersed active ingredients, moreover, is not possible since the particles stick to one another.

A disadvantage of the formulations known from the prior art (whether in the form of suspension concentrate or water-dispersible granules) is that high amounts of organic solvents, which are undesirable in environmental terms and for the user, have to be used for dissolution of the safener.

There is therefore still a need for formulations in the form of aqueous dispersions which comprise a low-melting herbicide safener having a melting point range and which are produced without organic solvents, and solid water-dispersible granules producible therefrom. The water-dispersible granules should additionally not agglomerate or stick.

### SUMMARY

It was thus an object of the present disclosure to provide aqueous, solvent-free formulations (SCs) and solid water-dispersible formulations (WGs) based on a low-melting herbicide safener with a low melting temperature range.

The present disclosure provides a process for producing aqueous, solvent-free formulations, characterized in that at least one active agrochemical ingredient a) having a melting temperature range between 50° C. and 80° C. is first melted in a first step, then the melt is added to water while stirring, the water containing at least one ionic and/or nonionic dispersant b), and the mixture is cooled below the melting point of the active ingredient in a second step.

### DETAILED DESCRIPTION OF A PREFERRED EMBODIMENT

In the process according to the disclosure, the water preferably has a temperature between 0° C. and 40° C., preferably between 5° C. and 20° C.

Preferably, in the second step of the process according to the disclosure, the mixture is stirred during the cooling for a period of at least 5 minutes, preferably 5 minutes to 24 h, more preferably for 10 minutes to 15 hours, under the condition that mefenpyr-diethyl crystals can be detected under the microscope to an extent of at least 90% by weight, based on mefenpyr-diethyl used. In this case, the crystalline active ingredient should no longer have any amorphous structure.

In a preferred embodiment (I) of the process according to the disclosure, in the first step, component a) is added to an aqueous solution comprising an ionic dispersant b1) and a carrier material c1) and also a filler c2). Preferably, for this embodiment (I), in a third step, the crystallized product is ground, with at least 50% of the particles having a size of 1 to 5 μm (d50, volume particles). The formulations thus obtainable are technical concentrates (TCs).

It is likewise possible to add a nonionic dispersant b2) as well as the ionic dispersant b1) in the process according to the disclosure.

The present disclosure likewise provides technical concentrates (TCs) obtainable by the process according to the disclosure.

Preferably, after the third step of the process (I) according to the disclosure, the water is removed from the TC. More preferably, the water is removed with the aid of fluidized bed methodology. The products thus obtainable are water-dispersible granules (WGs). The present disclosure therefore also provides water-dispersible granules (WGs) obtainable by the process according to the disclosure.

Fluidized bed methodology is a standard process for producing water-dispersible granules (WGs). The principle is to inject the partial concentrate into a fluidized bed chamber. This dries and separates out the aqueous component at the elevated temperature that exists therein. This is effected by injection of hot gas, for example nitrogen. The dissolved or dispersed substances ultimately agglomerate to give solid granules.

In a further preferred embodiment (II) of the process according to the disclosure, in a first step, component a) is added to an aqueous solution comprising an ionic dispersant b1), a nonionic dispersant b2) and a carrier material c1). Preferably, for this embodiment (II), in a third step, the crystallized product is ground, with at least 50% of the particles having a size of 1 to 5 μm (d50, volume particles), and after the grinding an organic thickener d1) is added. The formulations obtainable by embodiment (II) are water-dispersible suspension concentrates (SCs).

The present disclosure likewise provides water-dispersible suspension concentrates (SCs) obtainable by the process according to the disclosure.

The grinding can be effected by the methods known in the prior art, for example by wet grinding of the components in ball mills (for example discontinuous ball mills, or continuous ball mills), or colloid mills (for example toothed colloid mills).

The proportion of water in the formulations according to the disclosure may in general be 25% to 98% by weight, preferably 35% to 85% by weight. The unit “% by weight” (percent by weight) here and in the overall description, unless defined otherwise, relates to the relative weight of the particular component based on the total weight of the formulation or part-concentrate. The formulation may typically contain residues of organic solvents from the additives of 0% to 5%. “Solvent-free” in the context of the disclosure means that component a) is added in liquid form without solvent and is not in dissolved form in the finished dispersions, but forms undissolved crystals (dispersion).

Suitable active ingredients a) are all active agrochemical ingredients which, in the solid state, have a melting temperature range between 50° C. and 80° C.

Examples of active ingredients a) having a melting temperature range between 5° and 80° C. include:

anilofos, acephate, benfluralin, bifenthrin, bupirimate, butralin, chloroacetic acid, cyfluthrin, cypermethrin, demeton-S-methyl sulphone, dimethametryn, dimethoate, dioxabenzofos, diphenylamine, dithiopyr, dodemorph acetate, esfenvalerate, ethalfluralin, ethofumesate, fenazaquin, fenitropan, fenoxycarb, fenuron-TCA, fenvalerate, fluoroglycofen-ethyl, flupyradifuron, flurazole, flurochloridone, fluroxypyr-meptyl, flusilazole, furalaxyl, haloxyfop-etotyl, haloxyfop-methyl, imazalil, ioxynil octanoate, isoprothiolane, metalaxyl, methomyl, methoprotryne, monocrotophos, nitrapyrin, nitrothal-isopropyl, penconazole, pendimethalin, permethrin, propamocarb hydrochloride, propaquizafop, pyrazophos, quizalofop-P-tefuryl, resmethrin, trichloroacetic acid, tetramethrin, thiofanox, triflumizole, pyridaphenthion, 2-phenylphenol, dimethylvinphos, beta-cypermethrin, famphur, clodinafop-propargyl, cloquintocet-mexyl, triazamate, tebufenpyrad, pyrimidifen, aldrin, bromophos, dialifos, pyriminobac-methyl, mefenpyr-diethyl, benzoylprop, benzoylprop-ethyl, binapacryl, camphechlor, chlorfenethol, chlorfenprop, chlorfenprop-methyl, chlorphoxim, crufomate, cyometrinil, 1,1-dichloro-2,2-bis(4-ethylphenyl) ethane, dimetilan, dinobuton, fenson, fenthiaprop, fenthiaprop-ethyl, fluenetil, glyodin, 2-isovalerylindane-1,3-dione, methoxyphenone, 2-methoxyethylmercury chloride, nitrofen, indanofan, acequinocyl, ipsdienol with(S)-cis-verbenol, fenoxanil, pyraclostrobin, trifloxystrobin, cyflufenamid, gamma-cyhalothrin, proquinazid, 2,6-diisopropylnaphthalene, isotianil.

Active ingredient a) used with preference are those compounds which are in the form of esters and have a melting temperature range. Particular preference is given to active ingredients from the group of the herbicide safeners. Very particular preference is given to mefenpyr-diethyl or cloquintocet-mexyl, very especial preference to mefenypr-diethyl. These formulations are preferably used in cereal crops.

The proportion of active ingredients (component a) in the formulations according to the disclosure is 0.5% to 40% by weight, preferably 0.5% to 30% by weight, more preferably 0.5% to 15% by weight and most preferably 1% to 8% by weight.

Suitable anionic dispersants b1), such as emulsifiers, surfactants wetting agents and dispersers, are, for example, alkali metal, alkaline earth metal or ammonium salts of sulphonates, sulphates, phosphates, carboxylates and mixtures thereof, for example the salts of alkylsulphonic acids or alkylphosphoric acids and alkylarylsulphonic or alkylarylphosphoric acids, diphenylsulphonates, alpha-olefinsulphonates, lignosulphonates, sulphonates of fatty acids and oils, sulphonates of ethoxylated alkylphenols, sulphonates of alkoxylated arylphenols, sulphonates of condensed naphthalenes, sulphonates of dodecyl- and tridecylbenzenes, sulphonates of naphthalenes and alkylnaphthalenes, sulphosuccinates or sulphosuccinamates. Examples of sulphates are sulphates of fatty acids and oils, of ethoxylated alkylphenols, of alcohols, of ethoxylated alcohols or of fatty acid esters. Examples of phosphates are phosphate esters. Examples of carboxylates are alkyl carboxylates and carboxylated alcohol ethoxylates or alkylphenol ethoxylates. Likewise suitable is the group of anionic emulsifiers of the alkali metal, alkaline earth metal and ammonium salts of the polystyrenesulphonic acids, salts of the polyvinylsulphonic acids, salts of the alkylnaphthalenesulphonic acids, salts of alkylnaphthalenesulphonic acid-formaldehyde condensation products, salts of condensation products of naphthalenesulphonic acid, phenolsulphonic acid and formaldehyde. Examples are calcium dodecylbenzenesulphonate such as Rhodocal® 70/B (Solvay), Phenylsulfonat CA100 (Clariant) or isopropylammonium dodecylbenzenesulphonates such as Atlox® 3300B (Croda).

Further typical representatives include Phenylsulfonat CA (calcium dodecylbenzenesulphonate), Soprophor® products (optionally esterified derivatives of tristyrylphenol ethoxylates), Emulsogen® 3510 (alkylated EO/PO copolymer), Emulsogen® EL 400 (ethoxylated castor oil), Tween® products (fatty acylated sorbitan ethoxylates), Calsogen® AR 100 (calcium dodecylbenzenesulphonate). Preference is given to combinations of salts of alkylated aromatic sulphonic acids, such as calcium phenylsulphonate and/or Calsogen® AR 100, with alkylated copolymers of ethylene oxide and propylene oxide, such as Emulsogen® 3510. Particular preference is given to combinations of salts of dodecylbenzenesulphonic acid, Calsogen® AR 100, with alkylated copolymer of ethylene oxide and propylene oxide, such as Emulsogen® 3510.

Examples of further anionic emulsifiers b1) from the group of the naphthalenesulphonates are Galoryl® MT 800 (sodium dibutylnaphthalenesulphonate), Morwet® IP (sodium diisopropylnaphthalenesulphonate) and Nekal® BX (alkylnaphthalenesulphonate). Examples of anionic surfactants from the group of the condensates of naphthalenesulphonates with formaldehyde are Galoryl® DT 201 (naphthalenesulphonic acid hydroxy polymer with formaldehyde and methylphenol sodium salt), Galoryl® DT 250 (condensate of phenol- and naphthalenesulphonates), Reserve® C (condensate of phenol- and naphthalenesulphonates) or Morwet® D-425, Tersperse® 2020. Preference is given to 1,2-dibutyl-or-diisobutyl-substituted naphthalenesulphonates, for example products such as Galoryl® MT 800 (CFPI-Nufarm) and Nekal® BX (BASF). Further typical surfactants are Soprophor® 3D33, Soprophor® 4D384, Soprophor® BSU, Soprophor® CY/8 (Solvay) and Hoe® S3474, and in the form of the Sapogenat® T products (Clariant), for example Sapogenat® T 100.

Useful nonionic dispersants b2), such as emulsifiers, wetting agents, surfactants and dispersers, include standard surface-active substances present in formulations of active agrochemical ingredients. Examples include ethoxylated nonylphenols, reaction products of linear or branched alcohols with ethylene oxide and/or propylene oxide, ethylene oxide-propylene oxide block copolymers, end group-capped and non-end group-capped alkoxylated linear and branched, saturated and unsaturated alcohols (e.g. butoxy polyethylene-polypropylene glycols), reaction products of alkylphenols with ethylene oxide and/or propylene oxide, ethylene oxide-propylene oxide block copolymers, polyethylene glycols and polypropylene glycols, and also fatty acid esters, fatty acid polyglycol ether esters, alkylsulphonates, alkylsulphates, arylsulphates, ethoxylated arylalkylphenols, for example tristyrylphenol ethoxylate having an average of 16 ethylene oxide units per molecule, and also ethoxylated and propoxylated arylalkylphenols, and also sulphated and phosphated arylalkylphenol ethoxylates or ethoxy- and propoxylates. Particular preference is given to tristyrylphenol alkoxylates and fatty acid polyglycol ether esters. Very particular preference is given to tristyrylphenol ethoxylates, tristyrylphenol ethoxy propoxylates and castor oil polyglycol ether esters, in each case individually or in mixtures. Additionally useful are additives, such as surfactants or esters of fatty acids, which contribute to improvement in biological efficacy. Suitable nonionic emulsifiers b2) are, for example, Soprophor® 796/P, Lucramul® CO30, Lucramul® HOT, Lucramul® PSI 100 or Synperonic® T304.

Suitable nonionic dispersers b2) may likewise be selected from the group comprising polyvinylpyrrolidone (PVP), polyvinyl alcohol, copolymer of PVP and dimethylaminoethyl methacrylate, butylated PVP, copolymer of vinyl chloride and vinyl acetate, and partially hydrolysed vinyl acetate, phenol resins, modified cellulose types, for example Luviskol® (polyvinylpyrrolidone), Mowiol® (polyvinyl alcohol) or modified cellulose. Preference is given to polyvinylpyrrolidone types, particular preference to types of low molecular weight such as Luviskol® K30 or Sokalan® K30.

Useful further nonionic emulsifiers b2) from the group of the di- and triblock copolymers of alkylene oxides are, for example, compounds based on ethylene oxide and propylene oxide, having mean molar masses between 200 and 10 000 and preferably 1000 to 4000 g/mol, where the proportion by mass of the polyethoxylated block varies between 10 and 80%, for example the Synperonic® PE series (Uniqema), the Pluronic PE series (BASF), the VOP® 32 or Genapol® PF series (Clariant).

The proportion of the anionic dispersing aids b1) required in the technical concentrates according to the disclosure is 2% to 35% by weight, preferably 3% to 30% by weight, preferably 5% to 25% by weight and most preferably 10% to 20% by weight.

The proportion of the anionic dispersing aids b1) required in the suspension concentrates according to the disclosure is 0.1% to 10% by weight, preferably 0.2% to 7% by weight and most preferably 0.3% to 4% by weight.

The proportion of the nonionic dispersing aids b2) required in the suspension concentrates according to the disclosure is 1% to 15% by weight, preferably 2% to 10% by weight and most preferably 2.5% to 8% by weight.

The present disclosure further provides solvent-free, water-dispersible technical concentrates (TCs) comprising
one or more active ingredients a) having a melting temperature range between 50 and 80° C.,
one or more anionic emulsifiers b1),
one or more nonionic emulsifiers b2),
at least one or more than one carrier material c1) and
at least one filler c2).

The present disclosure likewise provides solvent-free, water-dispersible suspension concentrates (SCs) comprising
one or more active ingredients a) having a melting temperature range between 5° and 80° C.,
one or more anionic emulsifiers b1),
one or more nonionic emulsifiers b2),
a carrier material c1) and
at least one or more than one thickener d).

Suitable carrier materials c1) are selected from the group of the highly absorptive carriers having an absorption capacity of at least 200 g of dibutyl phthalate per 100 g of carrier material.

Preferred highly absorptive carriers c1) are silicas, for example Sipernat® products (synthetic precipitated silicas of high absorptivity) and fumed silica (Aerosil® products). Preference is given to precipitated silica.

The proportion of the fillers c1) required in the TCs according to the disclosure is 0.1% to 10% by weight, preferably 0.3% to 8% by weight and most preferably 1% to 7% by weight.

The proportion of the fillers c1) required in the SCs according to the disclosure is 0.05% to 10% by weight, preferably 0.1% to 8% by weight, preferably 0.3% to 5% and most preferably 0.5% to 3% by weight.

The fillers c2) in the WGs or TCs according to the disclosure are selected from the group comprising minerals, carbonates, sulphates and phosphates of alkaline earth metals and alkali metals, such as calcium carbonate, polymeric carbohydrates, framework silicates, such as precipitated silicas having low absorption, and natural framework silicates, such as kaolin. Typical representatives of suitable fillers c2) are, for example, Agsorb® LVM®-GA (attapulgite), Harborlite® 300 (pearlite), Collys® HV (modified starch), Omya®-Kreide (calcium carbonate), Kaolin Tec 1 (kaolin, aluminium hydrosilicate), Steamic® OOS (talc, magnesium silicate). For c2), preference is given here to natural framework silicates and calcium carbonate products such as Omya® chalk (calcium carbonate), Kaolin Tec 1® (kaolin) and Harborlite® 300 (pearlite), particular preference to natural framework silicates such as Kaolin®, Tec® 1 (kaolin, aluminium hydrosilicate) and Harborlite® 300 (pearlite). For c2), very particular preference is given to kaolin and calcium carbonate.

The proportion of the fillers c2) required in the TCs or WGs according to the disclosure is 2% to 35% by weight, preferably 3% to 30% by weight, preferably 5% to 25% by weight and most preferably 10% to 20% by weight.

Useful thickeners d) include organic thickeners d1) and inorganic thickeners d2).

Useful organic thickeners d1) include organic natural or biotechnologically modified or organic synthetic thickeners. Typical synthetic thickeners are Rheostrux® (Croda) or the Thixin® or Thixatrol® series (Elementis). These are typically based on acrylates. Typical organic thickeners are based on xanthan or cellulose (for instance hydroxyethyl or carboxymethyl cellulose) or a combination thereof. Further typical representatives are based on lignin (such as lignosulphonates, Borresperse® NA, REAX® 88 or Kraftsperse 25 S). Preference is given to using natural modified thickeners based on xanthan. Typical representatives are, for example, Rhodopol® (Solvay) and Kelzan® (Kelco Corp.), and also Satiaxane® (Cargill).

The proportion of the organic thickeners d1) in the SCs according to the disclosure is not more than 5% by weight, preferably 0.01% to 1.0% by weight, more preferably 0.01% to 0.6% by weight, even more preferably 0.05% to 0.5% by weight and even more preferably 0.1% to 0.3% by weight.

Suitable inorganic thickeners d2) are, for example, modified natural silicates such as chemically modified bentonites, hectorites, attapulgites, montmorillonites, smectites or other silicate minerals such as Bentone® (Elementis), Attagel® (Engelhard), Agsorb® (Oil-Dri Corporation) or Hectorite® (Akzo Nobel), or the Van Gel series (R.T. Vanderbilt).

The proportion of inorganic thickeners d2) in the SCs according to the disclosure is 0% to 5% by weight, preferably 0.1% to 3% by weight, more preferably 0.2% to 1.5% by weight, even more preferably 0.3% to 1.5% by weight and even more preferably 0.4% to 1.3% by weight.

Preference is given to using a mixture of thickener d1) and d2). Particular preference is given to using exclusively organic thickeners d1). Very particular preference is given to those thickeners d1) based on xanthan (such as Rhodopol® G from Solvay).

Suitable active agrochemical ingredients other than component a) that are optionally added (components e) are herbicides, fungicides, insecticides, plant growth regulators, safeners and the like.

Active fungicidal ingredients are, for example, 1) ergosterol biosynthesis inhibitors, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazole, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenole, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl) butan-2-ol (1.029) (2R)-2-(1-chlorocyclopropyl)-4-[(1S)-2,2-dichlorocyclopropyl]-1-(1H-1,2,4-triazol-1-yl) butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl) butan-2-ol, (1.032) (2S)-2-(1-chlorocyclopropyl)-4-[(1S)-2,2-dichlorocyclopropyl]-1-(1H-1,2,4-triazol-1-yl) butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl) methanol, (1.035) (S)-[3-(4-chloro-2-fluorophenyl)-5-(2,4-difluorophenyl)-1,2-oxazol-4-yl](pyridin-3-yl) methanol, (1.036) [3-(4-chloro-2-fluorophenyl)-5-(2,4-difluorophenyl)-1,2-oxazol-4-yl](pyridin-3-yl) methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl) oxiran-2-yl]methyl}-1H-1,2,4-triazol-5-yl thiocyanate, (1.040) 1-{[rel (2R,3R)-3-(2-chlorophenyl)-2-(2,4-difluorophenyl) oxiran-2-yl]methyl}-1H-1,2,4-triazol-5-yl thiocyanate, (1.041) 1-{[rel (2R,3S)-3-(2-chlorophenyl)-2-(2,4-difluorophenyl) oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl) butan-2-ol, (1.053) 2-[4-(4-chlorophenoxy)-2-(trifluoromethyl)phenyl]-1-(1H-1,2,4-triazol-1-yl) butan-2-ol, (1.054) 2-[4-(4-chlorophenoxy)-2-(trifluoromethyl)phenyl]-1-(1H-1,2,4-triazol-1-yl) pentan-2-ol, (1.055) 2-[4-(4-chlorophenoxy)-2-(trifluoromethyl)phenyl]-1-(1H-1,2,4-triazol-1-yl)propan-2-ol, (1.056) 2-{[3-(2-chlorophenyl)-2-(2,4-difluorophenyl) oxiran-2-yl]methyl}-2,4-dihydro-3H-1,2,4-triazole-3-thione, (1.057) 2-{[rel (2R,3R)-3-(2-chlorophenyl)-2-(2,4-difluorophenyl) oxiran-2-yl]methyl}-2,4-dihydro-3H-1,2,4-triazole-3-thione, (1.058) 2-{[rel (2R,3S)-3-(2-chlorophenyl)-2-(2,4-difluorophenyl) oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulphanyl)-1-{[3-(2-chlorophenyl)-2-(2,4-difluorophenyl) oxiran-2-yl]methyl}-1H-1,2,4-triazole, (1.061) 5-(allylsulphanyl)-1-{[rel (2R,3R)-3-(2-chlorophenyl)-2-(2,4-difluorophenyl) oxiran-2-yl]methyl}-1H-1,2,4-triazole, (1.062) 5-(allylsulphanyl)-1-{[rel (2R,3S)-3-(2-chlorophenyl)-2-(2,4-difluorophenyl) oxiran-2-yl]methyl}-1H-1,2,4-triazole, (1.063) N′-(2,5-dimethyl-4-{[3-(1,1,2,2-tetrafluoroethoxy)phenyl]sulphanyl}phenyl)-N-ethyl-N-methylimidoformamide, (1.064) N′-(2,5-dimethyl-4-{[3-(2,2,2-trifluoroethoxy)phenyl]sulphanyl}phenyl)-N-ethyl-N-methylimidoformamide, (1.065) N′-(2,5-dimethyl-4-{[3-(2,2,3,3-tetrafluoropropoxy)phenyl]sulphanyl}phenyl)-N-ethyl-N-methylimidoformamide, (1.066) N′-(2,5-dimethyl-4-{[3-(pentafluoroethoxy)phenyl]sulphanyl}phenyl)-N-ethyl-N-methylimidoformamide, (1.067) N′-(2,5-dimethyl-4-{3-[(1,1,2,2-tetrafluoroethyl)sulphanyl]phenoxy}phenyl)-N-ethyl-N-methylimidoformamide, (1.068) N′-(2,5-dimethyl-4-{3-[(2,2,2-trifluoroethyl)sulphanyl]phenoxy}phenyl)-N-ethyl-N-methylimidoformamide, (1.069) N′-(2,5-dimethyl-4-{3-[(2,2,3,3-tetrafluoropropyl)sulphanyl]phenoxy}phenyl)-N-ethyl-N-methylimidoformamide, (1.070) N′-(2,5-dimethyl-4-{3-[(pentafluoroethyl)sulphanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulphanyl}-2,5-dimethylphenyl)-N-ethyl-N-methylimidoformamide, (1.073) N′-(4-{3-[(difluoromethyl)sulphanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl) ethoxy]-2-methylpyridin-3-yl}-N-ethyl-N-methylimidoformamide, (1.077) N′-{5-bromo-6-[(1S)-1-(3,5-difluorophenyl) ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl) ethoxy]-2-methylpyridin-3-yl}-N-ethyl-N-methylimidoformamide, (1.081) mefentrifluconazole, (1.082) ipfentrifluconazole.

2) Inhibitors of the respiratory chain in complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of the syn-epimeric racemate 1RS,4SR,9RS and the anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl) biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) 3-(difluoromethyl)-N-(7-fluoro-1,1,3-trimethyl-2,3-dihydro-1H-inden-4-yl)-1-methyl-1H-pyrazole-4-carboxamide, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034)N-(2-cyclopentyl-5-fluorobenzyl)-N-cyclopropyl-3-(difluoromethyl)-5-fluoro-1-methyl-1H-pyrazole-4-carboxamide, (2.035)N-(2-tert-butyl-5-methylbenzyl)-N-cyclopropyl-3-(difluoromethyl)-5-fluoro-1-methyl-1H-pyrazole-4-carboxamide, (2.036)N-(2-tert-butylbenzyl)-N-cyclopropyl-3-(difluoromethyl)-5-fluoro-1-methyl-1H-pyrazole-4-carboxamide, (2.037)N-(5-chloro-2-ethylbenzyl)-N-cyclopropyl-3-(difluoromethyl)-5-fluoro-1-methyl-1H-pyrazole-4-carboxamide, (2.038)N-(5-chloro-2-isopropylbenzyl)-N-cyclopropyl-3-(difluoromethyl)-5-fluoro-1-methyl-1H-pyrazole-4-carboxamide, (2.039)N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040)N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041)N-[1-(2,4-dichlorophenyl)-1-methoxypropan-2-yl]-3-(difluoromethyl)-1-methyl-1H-pyrazole-4-carboxamide, (2.042)N-[2-chloro-6-(trifluoromethyl)benzyl]-N-cyclopropyl-3-(difluoromethyl)-5-fluoro-1-methyl-1H-pyrazole-4-carboxamide, (2.043)N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044)N-[5-chloro-2-(trifluoromethyl)benzyl]-N-cyclopropyl-3-(difluoromethyl)-5-fluoro-1-methyl-1H-pyrazole-4-carboxamide, (2.045)N-cyclopropyl-3-(difluoromethyl)-5-fluoro-1-methyl-N-[5-methyl-2-(trifluoromethyl)benzyl]-1H-pyrazole-4-carboxamide, (2.046)N-cyclopropyl-3-(difluoromethyl)-5-fluoro-N-(2-fluoro-6-isopropylbenzyl)-1-methyl-1H-pyrazole-4-carboxamide, (2.047)N-cyclopropyl-3-(difluoromethyl)-5-fluoro-N-(2-isopropyl-5-methylbenzyl)-1-methyl-1H-pyrazole-4-carboxamide, (2.048)N-cyclopropyl-3-(difluoromethyl)-5-fluoro-N-(2-isopropylbenzyl)-1-methyl-1H-pyrazole-4-carbothioamide, (2.049)N-cyclopropyl-3-(difluoromethyl)-5-fluoro-N-(2-isopropylbenzyl)-1-methyl-1H-pyrazole-4-carboxamide, (2.050)N-cyclopropyl-3-(difluoromethyl)-5-fluoro-N-(5-fluoro-2-isopropylbenzyl)-1-methyl-1H-pyrazole-4-carboxamide, (2.051)N-cyclopropyl-3-(difluoromethyl)-N-(2-ethyl-4,5-dimethylbenzyl)-5-fluoro-1-methyl-1H-pyrazole-4-carboxamide, (2.052)N-cyclopropyl-3-(difluoromethyl)-N-(2-ethyl-5-fluorobenzyl)-5-fluoro-1-methyl-1H-pyrazole-4-carboxamide, (2.053)N-cyclopropyl-3-(difluoromethyl)-N-(2-ethyl-5-methylbenzyl)-5-fluoro-1-methyl-1H-pyrazole-4-carboxamide, (2.054)N-cyclopropyl-N-(2-cyclopropyl-5-fluorobenzyl)-3-(difluoromethyl)-5-fluoro-1-methyl-1H-pyrazole-4-carboxamide, (2.055)N-cyclopropyl-N-(2-cyclopropyl-5-methylbenzyl)-3-(difluoromethyl)-5-fluoro-1-methyl-1H-pyrazole-4-carboxamide, (2.056)N-cyclopropyl-N-(2-cyclopropylbenzyl)-3-(difluoromethyl)-5-fluoro-1-methyl-1H-pyrazole-4-carboxamide.

3) Inhibitors of the respiratory chain in complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadon, (3.010) fenamidon, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy) methoxy]-4-methoxypyridin-2-yl}carbonyl)amino]-6-methyl-4,9-dioxo-1,5-dioxonan-7-yl 2-methylpropanoate, (3.026) 2-{2-[(2,5-dimethylphenoxy)methyl]phenyl}-2-methoxy-N-methylacetamide, (3.027)N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl{5-[3-(2,4-dimethylphenyl)-1H-pyrazol-1-yl]-2-methylbenzyl}carbamate.

4) Mitosis and cell division inhibitors, for example (4.001) carbendazim, (4.002) diethofencarb, (4.003) ethaboxam, (4.004) fluopicolid, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl) pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023)N-(2-bromo-6-fluorophenyl)-4-(2-chloro-4-fluorophenyl)-1,3-dimethyl-1H-pyrazol-5-amine, (4.024)N-(2-bromophenyl)-4-(2-chloro-4-fluorophenyl)-1,3-dimethyl-1H-pyrazol-5-amine, (4.025)N-(4-chloro-2,6-difluorophenyl)-4-(2-chloro-4-fluorophenyl)-1,3-dimethyl-1H-pyrazol-5-amine.

5) Compounds having capacity for multisite activity, for example (5.001) Bordeaux mixture, (5.002) captafol, (5.003) captan, (5.004) chlorthalonil, (5.005) copper hydroxide, (5.006) copper naphthenate, (5.007) copper oxide, (5.008) copper oxychloride, (5.009) copper (2+)sulphate, (5.010) dithianon, (5.011) dodin, (5.012) folpet, (5.013) mancozeb, (5.014) maneb, (5.015) metiram, (5.016) zinc metiram, (5.017) copper oxine, (5.018) propineb, (5.019) sulphur and sulphur preparations including calcium polysulphide, (5.020) thiram, (5.021) zineb, (5.022) ziram, (5.023) 6-ethyl-5,7-dioxo-6,7-dihydro-5H-pyrrolo[3′,4′: 5,6][1,4]dithiino[2,3-c][1,2]thiazole-3-carbonitrile.

6) Compounds capable of triggering host defence, for example (6.001) acibenzolar-S-methyl, (6.002) isotianil, (6.003) probenazole, (6.004) tiadinil.

7) Amino acid and/or protein biosynthesis inhibitors, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.

(8) ATP production inhibitors, for example (8.001) silthiofam.

9) Cell wall synthesis inhibitors, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.

10) Lipid and membrane synthesis inhibitors, for example (10.001)propamocarb, (10.002) propamocarb hydrochloride, (10.003) tolclofos-methyl.

11) Melanin biosynthesis inhibitors, for example (11.001) tricyclazole, (11.002) 2,2,2-trifluoroethyl {3-methyl-1-[(4-methylbenzoyl) amino]butan-2-yl}carbamate.

12) Nucleic acid synthesis inhibitors, for example (12.001) benalaxyl, (12.002) benalaxyl-M (kiralaxyl), (12.003) metalaxyl, (12.004) metalaxyl-M (mefenoxam).

13) Signal transduction inhibitors, for example (13.001) fludioxonil, (13.002) iprodione, (13.003) procymidone, (13.004) proquinazid, (13.005) quinoxyfen, (13.006) vinclozolin.

14) Compounds that can act as uncouplers, for example (14.001) fluazinam, (14.002) meptyldinocap.

15) Further compounds, for example (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenon, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphonic acid and salts thereof, (15.026) propamocarb-fosetylate, (15.027) pyriofenone (chlazafenone) (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl) quinazoline, (15.034) 2,6-dimethyl-1H,5H-[1,4]dithiino[2,3-c: 5,6-c′]dipyrrole-1,3,5,7 (2H,6H)-tetrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl) piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl) piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl) piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulphonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulphonate, (15.041) 2-{2-[(7,8-difluoro-2-methylquinolin-3-yl)oxy]-6-fluorophenyl}propan-2-ol, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulphonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulphonate, (15.045) 2-phenylphenol and salts thereof, (15.046) 3-(4,4,5-trifluoro-3,3-dimethyl-3,4-dihydroisoquinolin-1-yl)quinoline, (15.047) 3-(4,4-difluoro-3,3-dimethyl-3,4-dihydroisoquinolin-1-yl)quinoline, (15.048) 4-amino-5-fluoropyrimidin-2-ol (tautomeric form: 4-amino-5-fluoropyrimidin-2 (1H)-one), (15.049) 4-oxo-4-[(2-phenylethyl) amino]butyric acid, (15.050) 5-amino-1,3,4-thiadiazole-2-thiol, (15.051) 5-chloro-N′-phenyl-N′-(prop-2-yn-1-yl)thiophene 2-sulphonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl{6-[({[(Z)-(1-methyl-1H-tetrazol-5-yl)(phenyl)methylene]amino}oxy)methyl]pyridin-2-yl}carbamate, (15.056) ethyl(2Z)-3-amino-2-cyano-3-phenylacrylate, (15.057) phenazine-1-carboxylic acid, (15.058)propyl 3,4,5-trihydroxybenzoate, (15.059) quinolin-8-ol, (15.060) quinolin-8-ol sulphate (2:1), (15.061) tert-butyl{6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulphonyl]-3,4-dihydropyrimidin-2 (1H)-one. Active insecticidal ingredients are, for example:

(1) Acetylcholinesterase (AChE) inhibitors, for example carbamates, e.g. alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, e.g. acephate, azamethiphos, azinphos-ethyl, azinphos-methyl, cadusafos, chlorethoxyfos, chlorfenvinphos, chlormephos, chloropyrifos, chloropyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel antagonists, for example cyclodiene-organochlorines, e.g. chlordane and endosulphan or phenylpyrazoles (fiproles), e.g. ethiprole and fipronil.

(3) Sodium channel modulators/voltage-gated sodium channel blockers, for example pyrethroids, e.g. acrinathrin, allethrin, d-cis-trans allethrin, d-trans allethrin, bifenthrin, bioallethrin, bioallethrin S-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin[(1R)-trans isomers], deltamethrin, empenthrin[(EZ)-(1R) isomers], esfenvalerate, etofenprox, fenpropathrin, fenvalerate, flucythrinate, flumethrin, tau-fluvalinate, halfenprox, imiprothrin, kadethrin, momfluorothrin, permethrin, phenothrin[(1R)-trans isomer], prallethrin, pyrethrins (pyrethrum), resmethrin, silafluofen, tefluthrin, tetramethrin, tetramethrin[(1R) isomers)], tralomethrin and transfluthrin or DDT or methoxychlor.

(4) Nicotinergic acetylcholine receptor (nAChR) agonists, for example neonicotinoids, e.g. acetamiprid, clothianidin, dinotefuran, imidacloprid, nitenpyram, thiacloprid and thiamethoxam or nicotine or sulphoxaflor or flupyradifurone.

(5) Allosteric activators of the nicotinergic acetylcholine receptor (nAChR), for example spinosyns, e.g. spinetoram and spinosad.

(6) Chloride channel activators, for example avermectins/milbemycins, e.g. abamectin, emamectin benzoate, lepimectin and milbemectin.

(7) Juvenile hormone imitators, for example, juvenile hormone analogues, e.g. hydroprene, kinoprene and methoprene or fenoxycarb or pyriproxyfen.

(8) Active ingredients with unknown or non-specific mechanisms of action, for example alkyl halides, e.g. methyl bromide and other alkyl halides; or chloropicrin or sulphuryl fluoride or borax or tartar emetic.

(9) Selective antifeedants, e.g. pymetrozine or flonicamid.

(10) Mite growth inhibitors, e.g. clofentezine, hexythiazox and diflovidazin or etoxazole.

(11) Microbial disruptors of the insect gut membrane, e.g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins: Cry1Ab, Cry1Ac, Cry1Fa, Cry2Ab, mCry3A, Cry3Ab, Cry3Bb, Cry34/35Ab1.

(12) Oxidative phosphorylation inhibitors, ATP disruptors, for example diafenthiuron or organotin compounds, e.g. azocyclotin, cyhexatin and fenbutatin oxide or propargite or tetradifon.

(13) Oxidative phosphorylation decouplers that interrupt the H proton gradient, for example chlorfenapyr, DNOC and sulphluramid.

(14) Nicotinergic acetylcholine receptor antagonists, for example bensultap, cartap hydrochloride, thiocyclam, and thiosultap-sodium.

(15) Inhibitors of chitin biosynthesis, type 0, for example bistrifluron, chlorfluazuron, diflubenzuron, flucycloxuron, flufenoxuron, hexaflumuron, lufenuron, novaluron, noviflumuron, teflubenzuron and triflumuron.

(16) Inhibitors of chitin biosynthesis, type 1, for example buprofezin.

(17) Moulting disruptors, dipteran, for example cyromazine.

(18) Ecdysone receptor agonists, for example chromafenozide, halofenozide, methoxyfenozide and tebufenozide.

(19) Octopaminergic agonists, for example amitraz.

(20) Complex-III electron transport inhibitors, for example hydramethylnon or acequinocyl or fluacrypyrim.

(21) Complex-I electron transport inhibitors, for example METI acaricides, e.g. fenazaquin, fenpyroximate, pyrimidifen, pyridaben, tebufenpyrad and tolfenpyrad or rotenone (Derris).

(22) Voltage-gated sodium channel blockers, for example indoxacarb or metaflumizone.

(23) Inhibitors of acetyl-CoA carboxylase, for example tetronic and tetramic acid derivatives, e.g. spirobudiclofen, spirodiclofen, spiromesifen and spirotetramat.

(24) Complex-IV electron transport inhibitors, for example phosphines, e.g. aluminium phosphide, calcium phosphide, phosphine and zinc phosphide or cyanide.

(25) Complex-II electron transport inhibitors, for example cyenopyrafen and cyflumetofen.

(28) Ryanodine receptor effectors, for example diamides, e.g. chlorantraniliprole, cyantraniliprole, flubendiamide and tetrachloroantraniliprole.

Further active insecticidal ingredients having an unknown or unclear mechanism of action, for example afidopyropen, afoxolaner, azadirachtin, benclothiaz, benzoximate, bifenazate, broflanilide, bromopropylate, chinomethionat, cryolite, cyclaniliprole, cycloxaprid, cyhalodiamide, dicloromezotiaz, dicofol, diflovidazin, flometoquin, fluazaindolizine, fluensulfone, flufenerim, flufenoxystrobin, flufiprole, fluhexafon, fluopyram, fluralaner, fluxametamide, fufenozide, guadipyr, heptafluthrin, imidaclothiz, iprodione, lotilaner, meperfluthrin, paichongding, pyflubumide, pyridalyl, pyrifluquinazon, pyriminostrobin, sarolaner, tetramethylfluthrin, tetraniliprole, tetrachlorantraniliprole, tioxazafen, thiofluoximate, triflumezopyrim and iodomethanes; and additionally preparations based on Bacillus firmus (I-1582, BioNeem, Votivo), and the following known active compounds: 1-{2-fluoro-4-methyl-5-[(2,2,2-trifluoroethyl)sulphinyl]phenyl}-3-(trifluoromethyl)-1H-1,2,4-triazol-5-amine (known from WO2006/043635), {1′-[(2E)-3-(4-chlorophenyl)prop-2-en-1-yl]-5-fluorospiro[indol-3,4′-piperidin]-1 (2H)-yl}(2-chloropyridin-4-yl) methanone (known from WO2003/106457), 2-chloro-N-[2-{1-[(2E)-3-(4-chlorophenyl)prop-2-en-1-yl]piperidin-4-yl}-4-(trifluoromethyl)phenyl]isonicotinamide (known from WO2006/003494), 3-(2,5-dimethylphenyl)-4-hydroxy-8-methoxy-1,8-diazaspiro[4.5]dec-3-en-2-one (known from WO2009/049851), 3-(2,5-dimethylphenyl)-8-methoxy-2-oxo-1,8-diazaspiro[4.5]dec-3-en-4-yl ethyl carbonate (known from WO2009/049851), 4-(but-2-yn-1-yloxy)-6-(3,5-dimethylpiperidin-1-yl)-5-fluoropyrimidine (known from WO2004/099160), 4-(but-2-yn-1-yloxy)-6-(3-chlorophenyl)pyrimidine (known from WO2003/076415), PF1364 (CAS Reg. No. 1204776-60-2), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate (known from WO2005/085216), methyl 2-[3,5-dibromo-2-({[3-bromo-1-(3-chloropyridin-2-yl)-1H-pyrazol-5-yl]carbonyl}amino) benzoyl]-2-ethylhydrazinecarboxylate (known from WO2005/085216), N-[2-(5-amino-1,3,4-thiadiazol-2-yl)-4-chloro-6-methylphenyl]-3-bromo-1-(3-chloropyridin-2-yl)-1H-pyrazole-5-carboxamide (known from CN102057925), 4-[5-(3,5-dichlorophenyl)-5-(trifluoromethyl)-4,5-dihydro-1,2-oxazol-3-yl]-2-methyl-N-(1-oxidothietan-3-yl)benzamide (known from WO2009/080250), N-[(2E)-1-[(6-chloropyridin-3-yl)methyl]pyridin-2 (1H)-ylidene]-2,2,2-trifluoroacetamide (known from WO2012/029672), 1-[(2-chloro-1,3-thiazol-5-yl)methyl]-4-oxo-3-phenyl-4H-pyrido[1,2-a]pyrimidin-1-ium-2-olate (known from WO2009/099929), 1-[(6-chloropyridin-3-yl)methyl]-4-oxo-3-phenyl-4H-pyrido[1,2-a]pyrimidin-1-ium-2-olate (known from WO2009/099929), 4-(3-{2,6-dichloro-4-[(3,3-dichloroprop-2-en-1-yl)oxy]phenoxy}propoxy)-2-methoxy-6-(trifluoromethyl)pyrimidine (known from CN101337940), N-[2-(tert-butylcarbamoyl)-4-chloro-6-methylphenyl]-1-(3-chloropyridin-2-yl)-3-(fluoromethoxy)-1H-pyrazole-5-carboxamide (known from WO2008/134969), butyl[2-(2,4-dichlorophenyl)-3-oxo-4-oxaspiro[4.5]dec-1-en-1-yl]carbonate (known from CN 102060818), (3E)-3-[1-[(6-chloro-3-pyridyl)methyl]-2-pyridylidene]-1, 1,1-trifluoropropan-2-one (known from WO2013/144213), N-(methylsulphonyl)-6-[2-(pyridin-3-yl)-1,3-thiazol-5-yl]pyridine-2-carboxamide (known from WO2012/000896), N-[3-(benzylcarbamoyl)-4-chlorophenyl]-1-methyl-3-(pentafluoroethyl)-4-(trifluoromethyl)-1H-pyrazole-5-carboxamide (known from WO2010/051926), 5-bromo-4-chloro-N-[4-chloro-2-methyl-6-(methylcarbamoyl)phenyl]-2-(3-chloro-2-pyridyl) pyrazole-3-carboxamide (known from CN103232431), tioxazafen, 4-[5-(3,5-dichlorophenyl)-4,5-dihydro-5-(trifluoromethyl)-3-isoxazolyl]-2-methyl-N-(cis-1-oxido-3-thietanyl)benzamide, 4-[5-(3,5-dichlorophenyl)-4,5-dihydro-5-(trifluoromethyl)-3-isoxazolyl]-2-methyl-N-(trans-1-oxido-3-thietanyl)benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013050317 A1), N-[3-chloro-1-(3-pyridinyl)-1H-pyrazol-4-yl]-N-ethyl-3-[(3,3,3-trifluoropropyl)sulphinyl]propanamide, (+)-N-[3-chloro-1-(3-pyridinyl)-1H-pyrazol-4-yl]-N-ethyl-3-[(3,3,3-trifluoropropyl)sulphinyl]propanamide and (−)-N-[3-chloro-1-(3-pyridinyl)-1H-pyrazol-4-yl]-N-ethyl-3-[(3,3,3-trifluoropropyl)sulphinyl]propanamide (known from WO 2013162715 A2, WO 2013162716 A2, US20140213448 A1), 5-[[(2E)-3-chloro-2-propen-1-yl]amino]-1-[2,6-dichloro-4-(trifluoromethyl)phenyl]-4-[(trifluoromethyl)sulphinyl]-1H-pyrazole-3-carbonitrile (known from CN 101337937 A), 3-bromo-N-[4-chloro-2-methyl-6-[(methylamino)thioxomethyl]phenyl]-1-(3-chloro-2-pyridinyl)-1H-pyrazole-5-carboxamide, (Liudaibenjiaxuanan, known CN from 103109816 A); N-[4-chloro-2-[[(1,1-dimethylethyl) amino]carbonyl]-6-methylphenyl]-1-(3-chloro-2-pyridinyl)-3-(fluoromethoxy)-1H-pyrazole-5-carboxamide (known from WO 2012034403 A1), N-[2-(5-amino-1,3,4-thiadiazol-2-yl)-4-chloro-6-methylphenyl]-3-bromo-1-(3-chloro-2-pyridinyl)-1H-pyrazole-5-carboxamide (known from WO 2011085575 A1), 4-[3-[2,6-dichloro-4-[(3,3-dichloro-2-propen-1-yl)oxy]phenoxy]propoxy]-2-methoxy-6-(trifluoromethyl)pyrimidine (known from CN 101337940 A); (2E)- and (2Z)-2-[2-(4-cyanophenyl)-1-[3-(trifluoromethyl)phenyl]ethylidene]-N-[4-(difluoromethoxy)phenyl]hydrazinecarboxamide (known from CN 101715774 A); 3-(2,2-dichloroethenyl)-2,2-dimethyl-4-(1H-benzimidazol-2-yl) phenyl cyclopropanecarboxylate (known from CN 103524422 A); methyl(4aS)-7-chloro-2,5-dihydro-2-[[(methoxycarbonyl) [4-[(trifluoromethyl)thio]phenyl]amino]carbonyl]-indeno[1,2-e][1,3,4]oxadiazine-4a (3H)-carboxylate (known from CN 102391261 A).

Examples of herbicidal mixing partners are:
acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-6-(4-chloro-2-fluoro-3-methylphenyl)-5-fluoropyridine-2-carboxylic acid, aminocyclopyrachlor, aminocyclopyrachlor-potassium, aminocyclopyrachlor-methyl, aminopyralid, amitrole, ammonium sulphamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bromacil, bromobutide, bromofenoxim, bromoxynil, bromoxynil-butyrate, -potassium, -heptanoate and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, chlorfenac, chlorfenac-sodium, chlorfenprop, chlorflurenol, chlorflurenol-methyl, chloridazon, chlorimuron, chlorimuron-ethyl, chlorophthalim, chlorotoluron, chlorthal-dimethyl, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyrimorate, cyclosulfamuron, cycloxydim, cyhalofop, cyhalofop-butyl, cyprazine, 2,4-D, 2,4-D-butotyl, -butyl, -dimethylammonium, -diolamin, -ethyl, 2-ethylhexyl, -isobutyl, -isooctyl, -isopropylammonium, -potassium, -triisopropanolammonium and-trolamine, 2,4-DB, 2,4-DB-butyl, -dimethylammonium, isooctyl, -potassium and -sodium, daimuron (dymron), dalapon, dazomet, n-decanol, desmedipham, detosyl-pyrazolate (DTP), dicamba, dichlobenil, 2-(2,4-dichlorobenzyl)-4,4-dimethyl-1,2-oxazolidin-3-one, 2-(2,5-dichlorobenzyl)-4,4-dimethyl-1,2-oxazolidin-3-one, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, dimetrasulfuron, dinitramine, dinoterb, diphenamid, diquat, diquat-dibromid, dithiopyr, diuron, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, F-9600, F-5231, i.e. N-[2-chloro-4-fluoro-5-[4-(3-fluoropropyl)-4,5-dihydro-5-oxo-1H-tetrazol-1-yl]-phenyl]ethanesulphonamide, F-7967, i.e. 3-[7-chloro-5-fluoro-2-(trifluoromethyl)-1H-benzimidazol-4-yl]-1-methyl-6-(trifluoromethyl)pyrimidine-2,4 (1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, flurochloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium and -trimesium, H-9201, i.e. O-(2,4-dimethyl-6-nitrophenyl)-O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl(2,4-dichlorophenoxy) acetate, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulphonyl)-5,5-dimethyl-4,5-dihydro-1,2-oxazole, ketospiradox, lactofen, lenacil, linuron, MCPA, MCPA-butotyl, -dimethylammonium, -2-ethylhexyl, -isopropylammonium, -potassium and -sodium, MCPB, MCPB-methyl, -ethyl and -sodium, mecoprop, mecoprop-sodium, and -butotyl, mecoprop-P, mecoprop-P-butotyl, -dimethylammonium, -2-ethylhexyl and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, methyl isothiocyanate, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-[3-chloro-4-(1-methylethyl)-phenyl]-2-methylpentanamide, NGGC-011, napropamide, NC-310, i.e. 4-(2,4-dichlorobenzoyl)-1-methyl-5-benzyloxypyrazol, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorophenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl) phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trifluoroacetic acid), TCA-sodium, tebuthiuron, tefuryltrione, tembotrione, tepraloxydim, terbacil, terbucarb, terbumeton, terbuthylazin, terbutryn, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, XDE-848, ZJ-0862, i.e. 3,4-dichloro-N-{2-[(4,6-dimethoxypyrimidin-2-yl)oxy]benzyl}aniline, and the following compounds:

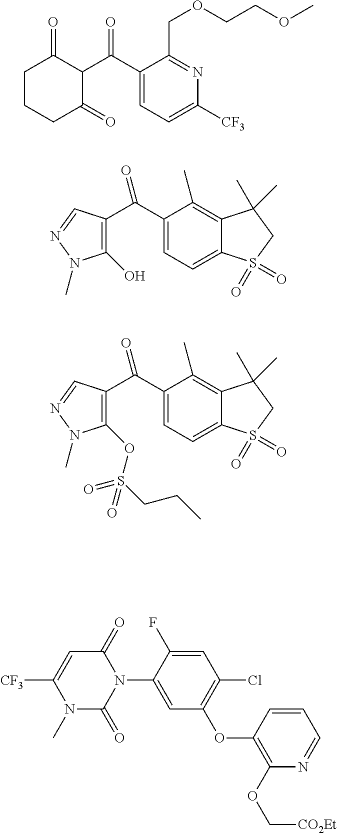 [SMILES: COCCOCc1nc(C(F)(F)F)ccc1C(=O)C1C(=O)CCCC1=O ; Cc1c(C(=O)c2cnn(C)c2O)ccc2c1C(C)(C)CS2(=O)=O ; CCCS(=O)(=O)Oc1c(C(=O)c2ccc3c(c2C)C(C)(C)CS3(=O)=O)cnn1C ; CCOC(=O)COc1ncccc1Oc1cc(-n2c(=O)cc(C(F)(F)F)n(C)c2=O)c(F)cc1Cl]

Examples of plant growth regulators as possible mixing partners are:

acibenzolar, acibenzolar-S-methyl, 5-aminolevulinic acid, ancymidol, 6-benzylaminopurine, brassinolide, catechol, chlormequat chloride, cloprop, cyclanilide, 3-(cycloprop-1-enyl)propionic acid, daminozide, dazomet, n-decanol, dikegulac, dikegulac-sodium, endothal, endothal-dipotassium, -disodium, and mono(N,N-dimethylalkylammonium), ethephon, flumetralin, flurenol, flurenol-butyl, flurprimidol, forchlorfenuron, gibberellic acid, inabenfide, indole-3-acetic acid (IAA), 4-indol-3-ylbutyric acid, isoprothiolane, probenazole, jasmonic acid, jasmonic acid methyl ester, maleic hydrazide, mepiquat chloride, 1-methylcyclopropene, 2-(1-naphthyl) acetamide, 1-naphthylacetic acid, 2-naphthyloxyacetic acid, nitrophenoxide mixture, 4-oxo-4 [(2-phenylethyl) amino]butyric acid, paclobutrazole, N-phenylphthalamic acid, prohexadione, prohexadione-calcium, prohydrojasmone, salicylic acid, strigolactone, tecnazene, thidiazuron, triacontanol, trinexapac, trinexapac-ethyl, tsitodef, uniconazole, uniconazole-P.

Examples of useful safeners include the following groups of compounds:
S1) Compounds from the group of heterocyclic carboxylic acid derivatives:
S1^{a}) Compounds of the dichlorophenylpyrazoline-3-carboxylic acid type (S1^{a}), preferably compounds such as
   1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr-diethyl”), and related compounds as described in WO-A-91/07874;
S1^{b}) Derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl) pyrazole-3-carboxylate (S1-4) and related compounds as described in EP-A-333 131 and EP-A-269 806;
S1^{c}) Derivatives of 1,5-diphenylpyrazole-3-carboxylic acid (S1^{c}), preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S1-6) and related compounds as described, for example, in EP-A-268554;
S1^{d}) Compounds of the triazolecarboxylic acid type (S1^{d}), preferably compounds such as fenchlorazole (ethyl ester), i.e. ethyl 1-(2,4-dichlorophenyl)-5-trichloromethyl-1H-1,2,4-triazole-3-carboxylate (S1-7), and related compounds, as described in EP-A-174 562 and EP-A-346 620;
S1^{e}) Compounds of the 5-benzyl- or 5-phenyl-2-isoxazoline-3-carboxylic acid or of the 5,5-diphenyl-2-isoxazoline-3-carboxylic acid type (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds as described in WO-A-91/08202, or 5,5-diphenyl-2-isoxazolinecarboxylic acid (S1-10) or ethyl 5,5-diphenyl-2-isoxazoline-3-carboxylate (S1-11) (“isoxadifen-ethyl”) or n-propyl 5,5-diphenyl-2-isoxazoline-3-carboxylate (S1-12) or ethyl 5-(4-fluorophenyl)-5-phenyl-2-isoxazoline-3-carboxylate (S1-13), as described in patent application WO-A-95/07897.
S2) Compounds from the group of the 8-quinolinyloxy derivatives (S2):
S2^{a}) Compounds of the 8-quinolinoxyacetic acid type (S2^{a}), preferably 1-methylhexyl(5-chloro-8-quinolinoxy) acetate (“cloquintocet-mexyl”) (S2-1), 1,3-dimethylbut-1-yl(5-chloro-8-quinolinoxy) acetate (S2-2), 4-allyloxybutyl(5-chloro-8-quinolinoxy) acetate (S2-3), 1-allyloxyprop-2-yl(5-chloro-8-quinolinoxy) acetate (S2-4), ethyl(5-chloro-8-quinolinoxy) acetate (S2-5), methyl 5-chloro-8-quinolinoxyacetate (S2-6), allyl(5-chloro-8-quinolinoxy) acetate (S2-7), 2-(2-propylideneiminoxy)-1-ethyl(5-chloro-8-quinolinoxy) acetate (S2-8), 2-oxoprop-1-yl(5-chloro-8-quinolinoxy) acetate (S2-9) and related compounds, as described in EP-A-86 750, EP-A-94 349 and EP-A-191 736 or EP-A-0 492 366, and also (5-chloro-8-quinolinoxy) acetic acid (S2-10), hydrates and salts thereof, for example the lithium, sodium, potassium, calcium, magnesium, aluminum, iron, ammonium, quaternary ammonium, sulphonium or phosphonium salts thereof, as described in WO-A-2002/34048;
S2^{b}) Compounds of the (5-chloro-8-quinolinoxy) malonic acid type (S2^{b}), preferably compounds such as diethyl(5-chloro-8-quinolinoxy) malonate, diallyl(5-chloro-8-quinolinoxy) malonate, methyl ethyl(5-chloro-8-quinolinoxy) malonate and related compounds, as described in EP-A-0 582 198.
S3) Active ingredients of the dichloroacetamide type (S3), which are frequently used as pre-emergence safeners (soil-acting safeners), for example “dichlormid” (N,N-diallyl-2,2-dichloroacetamide) (S3-1),
   “R-29148” (3-dichloroacetyl-2,2,5-trimethyl-1,3-oxazolidine) from Stauffer (S3-2),
   “R-28725” (3-dichloroacetyl-2,2-dimethyl-1,3-oxazolidine) from Stauffer (S3-3),
   “benoxacor” (4-dichloroacetyl-3,4-dihydro-3-methyl-2H-1,4-benzoxazine) (S3-4),
   “PPG-1292” (N-allyl-N-[(1,3-dioxolan-2-yl)methyl]dichloroacetamide) from PPG Industries (S3-5),
   “DKA-24” (N-allyl-N-[(allylaminocarbonyl)methyl]dichloroacetamide) from Sagro-Chem (S3-6),
   “AD-67” or “MON 4660” (3-dichloroacetyl-1-oxa-3-azaspiro[4.5]decane) from Nitrokemia or Monsanto (S3-7),
   “TI-35” (1-dichloroacetylazepane) from TRI-Chemical RT (S3-8),
   “Diclonon” (Dicyclonon) or “BAS145138” or “LAB145138” (S3-9)
   ((RS)-1-dichloroacetyl-3,3,8a-trimethylperhydropyrrolo[1,2-a]pyrimidin-6-one) from BASF,
   “furilazole” or “MON 13900” ((RS)-3-dichloroacetyl-5-(2-furyl)-2,2-dimethyloxazolidine) (S3-10), and the (R) isomer thereof (S3-11).
S4) Compounds from the class of the acylsulphonamides (S4):
S4^{a}) N-Acylsulphonamides of the formula (S4^{a}) and salts thereof, as described in WO-A-97/45016,

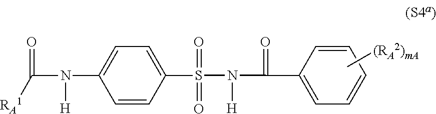

in which
   R_{A}¹ is (C₁-C₆)alkyl, (C₃-C₆)cycloalkyl, cycloalkyl, where the 2 latter radicals are substituted by v_{A} substituents from the group of halogen, (C₁-C₄)alkoxy, (C₁-C₆)haloalkoxy and (C₁-C₄)alkylthio and, in the case of cyclic radicals, also by (C₁-C₄)alkyl and (C₁-C₄)haloalkyl;
   R_{A}² is halogen, (C₁-C₄)alkyl, (C₁-C₄)alkoxy, CF₃;
   m_{A} is 1 or 2;
   v_{A} is 0, 1, 2 or 3;
S4^{b}) Compounds of the 4-(benzoylsulphamoyl)benzamide type of the formula (S4b) and salts thereof, as described in WO-A-99/16744,

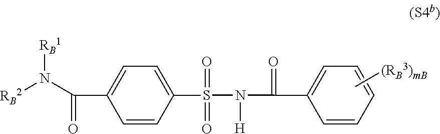

in which
R_{B}¹, R_{B}² are independently hydrogen, (C₁-C₆)alkyl, (C₃-C₆)cycloalkyl, (C₃-C₆) alkenyl, (C₃-C₆) alkynyl,
R_{B}³ is halogen, (C₁-C₄)alkyl, (C₁-C₄)haloalkyl or (C₁-C₄)alkoxy and
m_{B} is 1 or 2,
for example those in which
R_{B}¹=cyclopropyl, R_{B}²=hydrogen and (R_{B}³)=2-OMe (“cyprosulfamide”, S4-1),
R_{B}¹=cyclopropyl, R_{B}²=hydrogen and (R_{B}³)=5-C1-2-OMe (S4-2),
R_{B}¹=ethyl, R_{B}²=hydrogen and (R_{B}³)=2-OMe (S4-3),
R_{B}¹=isopropyl, R_{B}²=hydrogen and (R_{B}³)=5-C1-2-OMe (S4-4) and
R_{B}¹=isopropyl, R_{B}²=hydrogen and (R_{B}³)=2-OMe (S4-5);
S4^{c}) Compounds from the class of the benzoylsulphamoylphenylureas of the formula (S4c), as described in EP-A-365484,

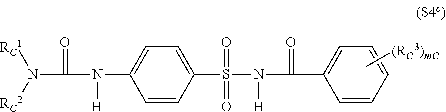

in which
R_{C}¹, R_{C}² are independently hydrogen, (C₁-C₅)alkyl, (C₃-C₈)cycloalkyl, (C₃-C₆) alkenyl, (C₃-C₆) alkynyl,
R_{C}³ is halogen, (C₁-C₄)alkyl, (C₁-C₄)alkoxy, CF₃ and
m_{C} is 1 or 2;
for example
1-[4-(N-2-methoxybenzoylsulphamoyl)phenyl]-3-methylurea,
1-[4-(N-2-methoxybenzoylsulphamoyl)phenyl]-3,3-dimethylurea,
1-[4-(N-4,5-dimethylbenzoylsulphamoyl)phenyl]-3-methylurea;
S4^{d}) Compounds of the N-phenylsulphonylterephthalamide type of the formula (S4^{d}) and salts thereof, which are known, for example, from CN 101838227,

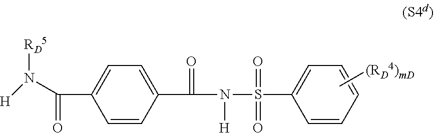

in which
R_{D}⁴ is halogen, (C₁-C₄)-alkyl, (C₁-C₄)-alkoxy, CF₃;
m_{D} is 1 or 2;
R_{D}⁵ is hydrogen, (C₁-C₆)-alkyl, (C₃-C₆)-cycloalkyl, (C₂-C₆)-alkenyl, (C₂-C₆)-alkynyl or (C₅-C₆)-cycloalkenyl.
S5) Active ingredients from the class of the hydroxyaromatics and the aromatic-aliphatic carboxylic acid derivatives (S5), for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 2-hydroxycinnamic acid, 2,4-dichlorocinnamic acid, as described in WO-A-2004/084631, WO-A-2005/015994, WO-A-2005/016001.
S6) Active ingredients from the class of the 1,2-dihydroquinoxalin-2-ones (S6), for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulphonylaminoethyl)-3-(2-thienyl)-1,2-dihydroquinoxalin-2-one, as described in WO-A-2005/112630.
S7) Compounds from the class of the diphenylmethoxyacetic acid derivatives (S7), for example methyl diphenylmethoxyacetate (CAS Reg. No. 41858-19-9) (S7-1), ethyl diphenylmethoxyacetate or diphenylmethoxyacetic acid, as described in WO-A-98/38856.
S8) Compounds of the formula (S8), as described in WO-A-98/27049,

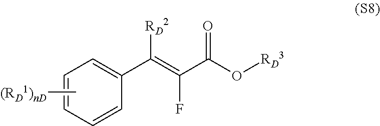

where the symbols and indices are defined as follows:
R_{D}¹ is halogen, (C₁-C₄)alkyl, (C₁-C₄)haloalkyl, (C₁-C₄)alkoxy, (C₁-C₄)haloalkoxy,
R_{D}² is hydrogen or (C₁-C₄)alkyl,
R_{D}³ is hydrogen, (C₁-C₈)-alkyl, (C₂-C₄)-alkenyl, (C₂-C₄)-alkynyl or aryl, where each of the aforementioned carbon-containing radicals is unsubstituted or substituted by one or more, preferably up to three identical or different radicals from the group consisting of halogen and alkoxy; or salts thereof,
n_{D} is an integer from 0 to 2.
S9) Active ingredients from the class of the 3-(5-tetrazolylcarbonyl)-2-quinolones (S9), for example 1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No. 95855-00-8), as described in WO-A-1999/000020.
S10) Compounds of the formula (S10^{a}) or (S10^{b})
   as described in WO-A-2007/023719 and WO-A-2007/023764

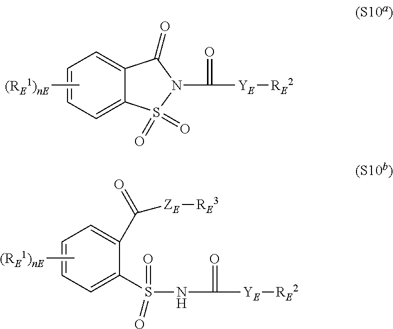

in which
R_{E}¹ is halogen, (C₁-C₄)alkyl, methoxy, nitro, cyano, CF₃, OCF₃
Y_{E}, Z_{E} are independently O or S,
n_{E} is an integer from 0 to 4,
R_{E}² is (C₁-C₁₆)alkyl, (C₂-C₆) alkenyl, (C₃-C₆)cycloalkyl, aryl; benzyl, halobenzyl,
R_{E}³ is hydrogen or (C₁-C₆)alkyl.
S11) Active ingredients of the oxyimino compound type (S11), which are known as seed-dressing agents, for example
   “oxabetrinil” ((Z)-1,3-dioxolan-2-ylmethoxyimino (phenyl) acetonitrile) (S11-1), which is known as a seed-dressing safener for millet/sorghum against metolachlor damage,
   “fluxofenim” (1-(4-chlorophenyl)-2,2,2-trifluoro-1-ethanone O-(1,3-dioxolan-2-ylmethyl) oxime) (S11-2), which is known as a seed-dressing safener for millet/sorghum against metolachlor damage, and
   “cyometrinil” or “CGA-43089” ((Z)-cyanomethoxyimino (phenyl) acetonitrile) (S11-3), which is known as a seed-dressing safener for millet/sorghum against metolachlor damage.
S12) Active ingredients from the class of the isothiochromanones (S12), for example methyl [(3-oxo-1H-2-benzothiopyran-4 (3H)-ylidene) methoxy]acetate (CAS Reg. No. 205121-04-6) (S12-1) and related compounds from WO-A-1998/13361.
S13) One or more compounds from group (S13):
   “naphthalic anhydride” (1,8-naphthalenedicarboxylic anhydride) (S13-1), which is known as a seed-dressing safener for corn against thiocarbamate herbicide damage,
   “fenclorim” (4,6-dichloro-2-phenylpyrimidine) (S13-2), which is known as a safener for pretilachlor in sown rice,
   “flurazole” (benzyl 2-chloro-4-trifluoromethyl-1,3-thiazole-5-carboxylate) (S13-3), which is known as a seed-dressing safener for millet/sorghum against alachlor and metolachlor damage,
   “CL 304415” (CAS Reg. No. 31541-57-8)
   (4-carboxy-3,4-dihydro-2H-1-benzopyran-4-acetic acid) (S13-4) from American Cyanamid, which is known as a safener for corn against damage by imidazolinones,
   “MG 191” (CAS Reg. No. 96420-72-3) (2-dichloromethyl-2-methyl-1,3-dioxolane) (S13-5) from Nitrokemia, which is known as a safener for corn,
   “MG 838” (CAS-Reg.Nr. 133993-74-5)
   (2-propenyl 1-oxa-4-azaspiro[4.5]decane-4-carbodithioate) (S13-6) from Nitrokemia
   “disulfoton” (O,O-diethyl S-2-ethylthioethyl phosphorodithioate) (S13-7),
   “dietholate” (O,O-diethyl O-phenyl phosphorothioate) (S13-8),
   “mephenate” (4-chlorophenyl methylcarbamate) (S13-9).
S14) Active ingredients which, in addition to herbicidal action against weeds, also have safener action on crop plants such as rice, for example
   “dimepiperate” or “MY-93” (S-1-methyl 1-phenylethylpiperidine-1-carbothioate), which is known as a safener for rice against damage by the herbicide molinate,
   “daimuron” or “SK 23” (1-(1-methyl-1-phenylethyl)-3-p-tolylurea), which is known as safener for rice against imazosulfuron herbicide damage,
   “cumyluron”= “JC-940” (3-(2-chlorophenylmethyl)-1-(1-methyl-1-phenylethyl) urea, see JP-A-60087254), which is known as safener for rice against damage by some herbicides,
   “methoxyphenone” or “NK 049” (3,3′-dimethyl-4-methoxybenzophenone), which is known as a safener for rice against damage by some herbicides,
   “CSB” (1-bromo-4-(chloromethylsulphonyl)benzene) from Kumiai, (CAS Reg. No. 54091-06-4), which is known as a safener against damage by some herbicides in rice.
S15) Compounds of the formula (S15) or tautomers thereof

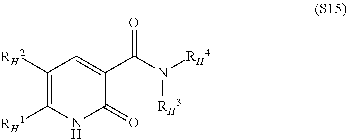

as described in WO-A-2008/131861 and WO-A-2008/131860
in which
R_{H}¹ is a (C₁-C₆)-haloalkyl radical and
R_{H}² is hydrogen or halogen and
R_{H}³, R_{H}⁴ are each independently hydrogen, (C₁-C₁₆)-alkyl, (C₂-C₁₆)-alkenyl or (C₂C₁₆)-alkynyl,
   where each of the 3 latter radicals is unsubstituted or substituted by one or more radicals from the group of halogen, hydroxyl, cyano, (C₁-C₄)-alkoxy, (C₁-C₄)-haloalkoxy, (C₁-C₄)-alkylthio, (C₁-C₄)-alkylamino, di[(C₁-C₄)-alkyl]amino, [(C₁-C₄)-alkoxy]carbonyl, [(C₁-C₄)-haloalkoxy]carbonyl, (C₃-C₆)-cycloalkyl which is unsubstituted or substituted, phenyl which is unsubstituted or substituted, and heterocyclyl which is unsubstituted or substituted,
   or (C₃-C₆)-cycloalkyl, (C₄-C₆)-cycloalkenyl, (C₃-C₆)-cycloalkyl fused on one side of the ring to a 4 to 6-membered saturated or unsaturated carbocyclic ring, or (C₄-C₆)-cycloalkenyl fused on one side of the ring to a 4 to 6-membered saturated or unsaturated carbocyclic ring,
   where each of the 4 latter radicals is unsubstituted or substituted by one or more radicals from the group of halogen, hydroxyl, cyano, (C₁-C₄)alkyl, (C₁-C₄)haloalkyl, (C₁-C₄)alkoxy, (C₁-C₄)haloalkoxy, (C₁-C₄)alkylthio, (C₁-C₄)alkylamino, di[(C₁-C₄)alkyl]amino, [(C₁-C₄)alkoxy]carbonyl, [(C₁-C₄)haloalkoxy]carbonyl, (C₃-C₆)cycloalkyl which is unsubstituted or substituted, phenyl which is unsubstituted or substituted, and heterocyclyl which is unsubstituted or substituted, or
R_{H}³ is (C₁-C₄)-alkoxy, (C₂-C₄)-alkenyloxy, (C₂-C₆)-alkynyloxy or (C₂-C₄)-haloalkoxy and
R_{H}⁴ is hydrogen or (C₁-C₄)-alkyl or
R_{H}³ and R_{H}⁴ together with the directly bonded nitrogen atom are a four- to eight-membered heterocyclic ring which, as well as the nitrogen atom, may also contain further ring heteroatoms, preferably up to two further ring heteroatoms from the group of N, O and S, and which is unsubstituted or substituted by one or more radicals from the group of halogen, cyano, nitro, (C₁-C₄)alkyl, (C₁-C₄)haloalkyl, (C₁-C₄)alkoxy, (C₁-C₄)haloalkoxy and (C₁-C₄)alkylthio.
S16) Active ingredients which are used primarily as herbicides but also have safener action on crop plants, for example
   (2,4-dichlorophenoxy) acetic acid (2,4-D),
   (4-chlorophenoxy) acetic acid,
   (R,S)-2-(4-chloro-o-tolyloxy)propionic acid (mecoprop),
   4-(2,4-dichlorophenoxy) butyric acid (2,4-DB),
   (4-chloro-o-tolyloxy) acetic acid (MCPA),
   4-(4-chloro-o-tolyloxy) butyric acid,
   4-(4-chlorophenoxy) butyric acid,
   3,6-dichloro-2-methoxybenzoic acid (dicamba),
   1-(ethoxycarbonyl)ethyl 3,6-dichloro-2-methoxybenzoate (lactidichlor-ethyl).

More preferably, the solvent-free, water-dispersible technical concentrates (TCs) contain
0.5% to 40% by weight, preferably 0.5% to 30% by weight and more preferably 0.5% to 15% by weight of component a),
2% to 35% by weight, preferably 3% to 30% by weight, preferably 5% to 25% by weight and most preferably 10% to 20% by weight of component b1),
0.1% to 10% by weight, preferably 0.3% to 8% by weight and most preferably 1% to 7% by weight of component c1),
2% to 35% by weight, preferably 3% to 30% by weight, preferably 5% to 25% by weight and most preferably 10% to 20% by weight of component c2).

Most preferably, these are combined with an active ingredient e) from the group of the herbicides, preferably the sulphonylureas, for instance mesosulfuron-methyl (0.5%-5% by weight), iodosulfurun-methyl-sodium or -acid (0.05%-10% by weight), amidosulfuron (0.5%-5% by weight), the HPPD (4-hydroxyphenylpyruvate dioxygenase) inhibitors, and further active ingredients from the group of the ALS (acetolactate synthase) inhibitors, for instance thiencarbazone-methyl (0.2%-5% by weight) and/or typical pigment bleachers, for instance diflufenican (2%-20% by weight). Preference is given to active ingredients based on iodosulfuron, amidosulfuron and mesosulfuron.

Very particular preference is given to using, as c2), kaolin or calcium carbonate in combination with a silica. Very particular preference is given to using a precipitated silica as c1), and very particular preference is given to combining calcium carbonate as c2) with a precipitated silica.

More preferably, the solvent-free, water-dispersible suspension concentrates contain
0.5% to 40% by weight, preferably 0.5% to 30% by weight and more preferably 0.5% to 15% by weight of component a),
0.1% to 10% by weight, preferably 0.2% to 7% by weight and most preferably 0.3% to 4% by weight of component b1),
1% to 15% by weight, preferably 2% to 10% by weight and most preferably 2.5% to 8% by weight of component b2),
0.05% to 10% by weight, preferably 0.1% to 8% by weight, preferably 0.3% to 5% and most preferably 0.5% to 3% by weight of component c1),
0.01% to 1.0% by weight, more preferably 0.01% to 0.6% by weight, even more preferably 0.05% to 0.5% by weight and even more preferably 0.1% to 0.3% by weight of component d1).

Most preferably, these are combined with an active ingredient e) from the group of the herbicides, preferably from the group of the auxins, for instance halauxifen-methyl (0.05%-5% by weight) and/or from the group of the inhibitors of pigment synthesis (pigment bleachers), for instance diflufenican 5-30% and from the group of the DOXP synthase inhibitors, for instance clomazone and preferably isoxazolidinone, 2-[(2,4-dichlorophenyl)methyl]-4,4-dimethyl-(CAS Number 81777-95-9) and/or from the group of the VLCFA inhibitors (“very long chain fatty acid”, inhibition of cell division for production of fatty acids) flufenacet (5%-30% by weight). Preference is given to using halauxifen-methyl and/or diflufenican.

In addition, the SCs or TCs or WGs according to the disclosure may optionally also comprise, as further components f):
wetting agents, pH adjusters, defoamers, biocides, disintegrants, adhesion promoters, antifreezes, preservatives, dyes or fertilizers, and surfactants other than component b).

Suitable defoamers are surface-active silicone- or silane-based compounds such as the Tegopren® products (Goldschmidt), the SER products (Wacker), and the Bevaloid® (Kemira), Rhodorsil® (Solvay) and Silcolapse® products (Blustar Silicones), preference being given to SER (Wacker), Rhodorsil® and Silcolapse® products, particular preference, for example, to products such as Silcolapse® 5020.

Suitable antifreezes are those from the group of the ureas, diols and polyols, such as ethylene glycol and propylene glycol, glycerol, preferably propylene glycol or glycerol.

Suitable preservatives are, for example, products such as Acticide MBS (Biozid, Thor Chemie), CIT, MIT or BIT, for instance Proxel® GXL (BIT), Acticide® SPX (MIT, CIT).

Suitable wetting agents are selected from the group of the naphthalenesulphonic acids and the group of the sulphosuccinic acid derivatives and the salts of these groups, which firstly include mono- and diesters of sulphosuccinic acid and salts thereof (sulphosuccinates), and secondly alkylated naphthalenesulphonic acids and salts thereof, for example Aerosol® OTB (dioctyl sulphosuccinate), Morwet® EFW (alkylated naphthalenesulphonates), Nekal® BX (alkylated naphthalenesulphonates), Galoryl® MT 804 (alkylated naphthalenesulphonates).

Preferred wetting agents here are the salts of the alkylated naphthalenesulphonic acids and the salts of dioctylsulphosuccinic acid, more preferably the sodium salts of alkylated naphthalenesulphonates, for example Morwet® EFW, and the sodium salts of dioctylsulphosuccinic acid, for example Aerosol® OTB.

Suitable adhesion promoters may be selected from the group of polyvinylpyrrolidone (PVP), polyvinyl alcohol, copolymer of PVP and dimethylaminoethyl methacrylate, butylated PVP, copolymer of vinyl chloride and vinyl acetate, sodium salt of the copolymer of propenesultanic acid and partially hydrolysed vinyl acetate, sodium caseinate, phenol resins, modified cellulose types, for example Luviskol® (polyvinylpyrrolidone), Mowiol® (polyvinyl alcohol), modified cellulose.

Preference is given to polyvinylpyrrolidone types, particular preference to types of low molecular weight such as Luviskol® K30.

Suitable disintegrants may be selected from the group of the modified carbohydrates, such as microcrystalline cellulose and crosslinked polyvinylpyrrolidones, for example Avicel® PH 101 (microcrystalline cellulose), Agrimer® XLF (crosslinked polyvinylpyrrolidone, Disintex® 200 (crosslinked polyvinylpyrrolidone). Preference is given to crosslinked polyvinylpyrrolidones, such as Agrimer® XLF.

Suitable antifoams may be selected from the group of the esters of phosphoric acid with lower alcohols, C₆-C₁₀ alcohols, silicone surfactants (suspoemulsions of hydrophobized silica particles in aqueous emulsion concentrates based on liquid silicone surfactants), such as polydimethylsiloxane, and the absorbates thereof onto solid carrier material, for example Rhodorsil® 432 (silicone surfactant), butyl phosphate, isobutyl phosphate, n-octanol, Wacker ASP15 (polydimethylsiloxane, absorbed on solid carrier), Antifoam®SE (polydimethylsiloxane). Preference is given to suspoemulsions of hydrophobized silica particles in aqueous emulsion concentrates based on liquid silicone surfactants, such as Antifoam® SE (polydimethylsiloxane), and solid antifoams, such as Wacker ASP 15 (polydimethylsiloxane).

Suitable emulsifiers, wetting agents and dispersants are, for example, nonionic emulsifiers and dispersants, for example:
polyalkoxylated, preferably polyethoxylated, saturated and unsaturated aliphatic alcohols having 8 to 24 carbon atoms in the alkyl radical, which derives from the corresponding fatty acids or from petrochemical products, and having 1 to 100 and preferably 2 to 50 ethylene oxide units (EO), where the free hydroxyl group has optionally been alkoxylated, for example Genapol® X and Genapol® O series (Clariant), Crovol M series (Croda) or Lutensol® series (BASF);
polyalkoxylated, preferably polyethoxylated, hydroxy fatty acids or glycerides containing hydroxy fatty acids, for example ricinine or castor oil, having an ethoxylation level between 10 and 80, preferably 25 to 40, for example Emulsogen® EL series (Clariant) or Agnique® CSO series (BASF);
polyalkoxylated, preferably polyethoxylated, sorbitan esters, for example Atplus® 309 F (Croda) or the Alkamuls® series (Solvay).

Preferred nonionic emulsifiers and dispersants are, for example, polyethoxylated alcohols and polyethoxylated triglycerides containing hydroxy fatty acids.

Ionic emulsifiers and dispersants are likewise suitable, for example:
polyalkoxylated, preferably polyethoxylated, emulsifiers/dispersants which have been ionically modified, for example by conversion of the terminal free hydroxyl function of the polyethylene oxide block to a sulphate or phosphate ester (e.g. as alkali metal and alkaline earth metal salts), for example Genapol® LRO or Dispergiermittel 3618 (Clariant), Emulphor® (BASF) or Crafol® AP (BASF);
alkali metal and alkaline earth metal salts of alkylarylsulphonic acids having a straight-chain or branched alkyl chain, such as Phenylsulfonat CA or Phenylsulfonat CAL (Clariant), Atlox® 3377BM (Croda), the Empiphos® TM series (Huntsman);
polyelectrolytes, such as polystyrenesulphonate or sulphonated unsaturated or aromatic polymers (polystyrenes, polybutadienes or polyterpenes).

The proportion of any further customary auxiliaries and additives f) added in the dispersions according to the disclosure may be up to 20% by weight, preferably up to 15% by weight.

The proportion of water in the dispersions according to the disclosure is 20% to 70% by weight, preferably 20% to 60% by weight, more preferably 30% to 55% by weight, most preferably 25% to 45% by weight.

The disclosure further relates to a herbicidal composition which can be produced from the SCs, TCs or WGs according to the disclosure by diluting with liquids, preferably water.

It may be advantageous to add further active ingredients to the herbicidal compositions thus obtained, preferably active agrochemical ingredients (for example as tankmix partners in the form of appropriate formulations) and/or auxiliaries and additives used customarily, for example self-emulsifying oils such as vegetable oils or paraffin oils and/or fertilizers. The present disclosure therefore also provides such compositions, preferably herbicidal compositions, based on the formulations according to the disclosure.

A particular embodiment of the disclosure relates to the use of the herbicidal compositions obtainable from the SCs, TCs or WGs according to the disclosure for control of unwanted plant growth, referred to hereinafter as “herbicidal compositions”.

The herbicidal compositions have excellent herbicidal efficacy against a broad spectrum of economically important mono- and dicotyledonous weeds. There is also good control over difficult-to-control perennial weeds which produce shoots from rhizomes, rootstocks or other permanent organs. The herbicidal compositions may be deployed by the pre-sowing, pre-emergence or post-emergence method for example. Specific examples of some representatives of the monocotyledonous and dicotyledonous weed flora which can be controlled by the herbicidal compositions are as follows, but there is no intention of any restriction to particular species through the enumeration.

Examples of weed species which are controlled efficiently are, among the monocotyledonous weed species, Apera spica venti, Avena spp., Alopecurus spp., Brachiaria spp., Digitaria spp., Lolium spp., Echinochloa spp., Panicum spp., Phalaris spp., Poa spp., Setaria spp. and also Bromus spp. such as Bromus catharticus, Bromus secalinus, Bromus erectus, Bromus tectorum and Bromus japonicus and Cyperus species from the annual group, and, among the perennial species, Agropyron, Cynodon, Imperata and Sorghum and also perennial Cyperus species. In the case of dicotyledonous weed species, the spectrum of action extends to species such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

The herbicidal compositions also have excellent control over weeds that occur under the specific growing conditions that occur in rice, for example Echinochloa, Sagittaria, Alisma, Eleocharis, Scirpus and Cyperus. If the herbicidal compositions are applied to the soil surface before germination, either the weed seedlings are prevented completely from emerging or the weeds grow until they have reached the cotyledon stage, but then stop growing, and eventually, after three to four weeks have elapsed, die completely.

If the herbicidal compositions are applied post-emergence to the green parts of the plants, growth likewise stops drastically a very short time after the treatment, and the weed plants remain in the growth stage at the point of time of application, or they die completely after a certain time, so that in this manner competition by the weeds, which is harmful to the crop plants, is eliminated very early and in a sustained manner.

The herbicidal compositions are notable for a rapid onset and long duration of herbicidal action. The rain resistance of the active ingredients in the herbicidal compositions is generally favourable. A particular advantage is that the effective dosages, used in the herbicidal compositions, of herbicidal compounds can be adjusted to such a low level that the soil action thereof is optimally low. Therefore, the use thereof in sensitive crops is not just enabled, but groundwater contamination is also virtually prevented. The combination of active ingredients enables a considerable reduction in the necessary application rate of the active ingredients.

Said properties and advantages are beneficial in practical weed control in order to keep agricultural crops clear of unwanted competing plants and hence to ensure and/or increase the yields in terms of quality and quantity. The technical standard is markedly improved upon by these novel herbicidal compositions in terms of the properties described.

Even though the herbicidal compositions have excellent herbicidal activity against monocotyledonous and dicotyledonous weeds, there is only insignificant damage, if any, to crop plants of economically important crops, for example dicotyledonous crops such as soya, cotton, oilseed rape, sugar beet, or gramineous crops such as wheat, barley, rye, oats, millet/sorghum, rice or corn. For these reasons, the present herbicidal compositions are of very good suitability for selective control of unwanted plant growth in agriculturally useful plants or in ornamental plants.

Furthermore, the corresponding herbicidal compositions, according to the crop plant, have excellent growth-regulating properties They intervene in the plants' own metabolism with regulatory effect, and can thus be used for the controlled influencing of plant constituents and to facilitate harvesting, for example by triggering desiccation and stunted growth. Furthermore, they are potentially also suitable for the general control and inhibition of unwanted vegetative growth without killing the plants in the process. Inhibition of vegetative growth plays a major role for many mono- and dicotyledonous crops since this can, for example, reduce or completely prevent lodging.

By virtue of their herbicidal and plant growth regulatory properties, the herbicidal compositions—as already mentioned—can also be used to control weeds in crops of genetically modified plants which are known or yet to be developed. In general, the transgenic plants are characterized by particular advantageous properties, for example by resistances to certain pesticides, in particular certain herbicides, resistances to plant diseases or pathogens of plant diseases, such as certain insects or microorganisms such as fungi, bacteria or viruses. Other particular properties relate, for example, to the harvested material with regard to quantity, quality, storability, composition and specific constituents. For instance, there are known transgenic plants with an elevated starch content or altered starch quality, or those with a different fatty acid composition in the harvested material.

Preference is given to the use of the herbicidal compositions in economically important transgenic crops of useful plants and ornamentals, for example of gramineous crops such as wheat, barley, rye, oats, millet/sorghum, rice and corn, or else crops of sugar beet, cotton, soya, oilseed rape, potatoes, tomatoes, peas and other vegetables. The herbicidal compositions can preferably be used in crops of useful plants which are resistant, or have been made resistant by recombinant means, to the phytotoxic effects of the herbicides.

When the herbicidal compositions are employed in transgenic crops, not only do the effects toward harmful plants observed in other crops occur, but frequently also effects which are specific to application in the particular transgenic crop, for example an altered or specifically widened spectrum of weeds which can be controlled, altered application rates which can be used for the application, preferably good combinability with the further active herbicidal ingredients to which the transgenic crop is resistant, and influencing of growth and yield of the transgenic crop plants.

The present disclosure thus also provides a method for controlling unwanted plant growth, preferably in crop plants such as cereals (e.g. wheat, barley, rye, oats, rice, corn, millet/sorghum), sugar beet, sugar cane, oilseed rape, cotton and soya, more preferably in monocotyledonous crops such as cereals, for example wheat, barley, rye, oats, crossbreeds thereof, such as triticale, rice, corn and millet/sorghum, which is characterized in that the herbicidal compositions according to the disclosure are applied to the weeds, plant parts, plant seeds or the area in which the plants grow, for example the area under cultivation. The crop plants may also have been genetically modified or obtained by mutation selection and are preferably tolerant to acetolactate synthase (ALS) inhibitors.

With the WGs and SCs according to the disclosure, a better biological effect can be achieved at the same application rate. Advantageously, the SCs, TCs or WGs according to the disclosure exhibit excellent plant compatibility, such as a reduced tendency to phytotoxic damage.

In addition, the SCs, TCs or WGs according to the disclosure in the form of specific active ingredient combination formulations (synonyms: mixture formulations, co-formulations) have further advantages, for example lower expenditure on packaging than in the case of use of the individual active ingredients, as a result of which the cost and inconvenience associated with production, transport and storage is reduced and the preparation of the spray liquors used in agriculture is better manageable through the smaller amounts and the effective ratios that have already been set, for example in the measuring and stirring operation.

The SCs, TCs or WGs according to the disclosure surprisingly additionally exhibit excellent dispersing and stabilizing properties after further dilution with liquids, preferably water.

In addition, the SCs, TCs or WGs give rise to formulations having prolonged storage stability and impeccable applicability.

A further preferred embodiment is the use of the SCs, TCs or WGs according to the disclosure as growth regulator (phytotonic). Preferably, these combinations are used to improve the “greening” of the plant.

Plant growth regulators can exert various effects on plants. The effect of the substances depends essentially on the time of application relative to the development stage of the plant, and also on the amounts of active ingredient that are deployed to the plants or their environment and on the manner of deployment. In each case, growth regulators should exert a particular desired effect on the crop plants.

The growth-regulating effects include earlier germination, better emergence, a more highly developed root system and/or improved root growth, enhanced tillering capacity, more productive tillers, earlier flowers, increased plant height and/or biomass, stem shortening, improvements in shoot growth, number of grains/ears, number of ears/m², number of stolons and/or number of flowers, increased harvest index, larger leaves, fewer dead basal leaves, improved phyllotaxy, earlier maturity/earlier fruit formation, homogeneous maturity, increased grain filling time, better fruit formation, larger fruit/vegetable size, shoot resistance and reduced lodging.

Elevated or improved yield relates to total biomass per hectare, yield per hectare, grain/fruit weight, seed size and/or hectolitre weight, and to improved product quality, comprising the following:
improved processibility with regard to size distribution (grain, fruit, etc.), homogeneous maturity, grain moisture, better milling, better wine processing, better brewing, elevated juice yield, elevated harvestability, elevated digestibility, elevated sedimentation value, elevated drop count, elevated husk stability, elevated storage stability, improved fibre length/thickness/homogeneity, elevated milk and/or meat quality of silage-fed animals, adaptation to cooking and frying;
further comprising better marketability in relation to elevated fruit/grain quality, size distribution (grain, fruit, etc.), elevated storability/shelf life, firmness/softness, flavour (aroma, texture, etc.), class (size, shape, number of berries, etc.), number of berries/fruits per bunch, crispness, freshness, wax coverage, frequency of physiological disorders, colour, etc.;
further comprising an increase in the desired constituents, for example protein content, fatty acids, oil content, oil quality, amino acid composition, sugar content, acid content (pH), sugar/acid value (Brix), polyphenols, starch content, nutritional value, gluten content/index, energy content, flavour, etc.;
and further comprising a reduction in unwanted constituents, for example fewer mycotoxins, fewer aflatoxins, geosmin content, phenol aromas, laccase, polyphenol oxidases and peroxidases or nitrate content.

Plant growth-regulating formulations may be used, for example, to slow the vegetative growth of the plants. Such suppression of growth is of economic interest for example in the case of grasses, since it is possible in this way to reduce the frequency of grass cutting in ornamental gardens, parks and sports facilities, on road margins, at airports or in fruit crops. Likewise important is the inhibition of growth of herbaceous and woody plants on road margins and close to pipelines or above-ground cables, or generally wherever vigorous plant growth is unwanted.

Likewise important is the use of plant growth regulators for inhibition of the longitudinal growth of cereals. This reduces or entirely eliminates the risk of lodging of the plants prior to harvesting. In addition, growth regulators can strengthen the stem in cereals, which likewise counteracts lodging. The use of growth regulators for shortening and strengthening the stems permits the deployment of greater amounts of fertilizer, in order to increase the yield, without any risk of lodging of the cereal crop.

In the case of many crop plants, the suppression of vegetative growth permits greater plant density, and it is therefore possible to achieve higher numbers in relation to the soil surface area. A further advantage of the smaller plants obtained in this manner is that the crop is easier to cultivate and to harvest.

The reduction in vegetative plant growth can also lead to elevated or improved yields, since the nutrients and assimilates are of greater benefit for flower and fruit formation than for the vegetative parts of the plants.

Alternatively, growth regulators can also be used to promote vegetative growth. This is of great benefit when harvesting the vegetative plant parts. However, promoting vegetative growth may also promote generative growth in that more assimilates are formed, resulting in more or larger fruits.

Furthermore, beneficial effects on growth or yield can be achieved through improved nutrient use efficiency, especially nitrogen (N) use efficiency, phosphorus (P) use efficiency, water use efficiency, improved transpiration, respiration and/or CO2 assimilation rate, better nodulation, improved Ca metabolism etc.

Likewise, growth regulators can be used to alter the composition of the plants, which in turn may result in an improvement in quality of the harvested product. Under the influence of growth regulators, parthenocarpic fruits may be formed. In addition, it is possible to influence the sex of the flowers. It is also possible to produce sterile pollen, which is of great importance in the breeding and production of hybrid seed.

Use of growth regulators can control the branching of the plants. On the one hand, by breaking apical dominance, it is possible to promote the development of side shoots, which may be highly desirable particularly in the cultivation of ornamental plants, also in combination with an inhibition of growth. On the other hand, however, it is also possible to inhibit the growth of the side shoots. This effect is of particular interest, for example, in the cultivation of tobacco or in the cultivation of tomatoes.

Under the influence of growth regulators, the amount of leaves on the plants can be controlled such that defoliation of the plants is achieved at a desired time. Such defoliation plays a major role in the mechanical harvesting of cotton, but is also of interest for facilitating harvesting in other crops, for example in viticulture. Defoliation of the plants can also be undertaken to lower the transpiration of the plants before they are transplanted.

Furthermore, growth regulators can modulate plant senescence, which may result in prolonged green leaf area duration, a longer grain filling phase, improved yield quality, etc.

Growth regulators can likewise be used to regulate fruit dehiscence. On the one hand, it is possible to prevent premature fruit dehiscence. On the other hand, it is also possible to promote fruit dehiscence or even flower abortion to achieve a desired mass (“thinning”). In addition it is possible to use growth regulators at the time of harvest to reduce the forces required to detach the fruits, in order to allow mechanical harvesting or to facilitate manual harvesting.

Growth regulators can also be used to achieve faster or else delayed ripening of the harvested material before or after harvest. This is particularly advantageous as it allows optimal adjustment to the requirements of the market. Moreover, growth regulators in some cases can improve the fruit colour. In addition, growth regulators can also be used to synchronize maturation within a certain period of time. This establishes the prerequisites for complete mechanical or manual harvesting in a single operation, for example in the case of tobacco, tomatoes or coffee.

By using growth regulators, it is additionally possible to influence the resting of seed or buds of the plants, such that plants such as pineapple or ornamental plants in nurseries, for example, germinate, sprout or flower at a time when they are normally not inclined to do so. In areas where there is a risk of frost, it may be desirable to delay budding or germination of seeds with the aid of growth regulators, in order to avoid damage resulting from late frosts.

Finally, growth regulators can induce resistance of the plants to frost, drought or high salinity of the soil. This allows the cultivation of plants in regions which are normally unsuitable for this purpose.

The formulations according to the disclosure also exhibit a potent strengthening effect in plants. Accordingly, they can be used for mobilizing the defences of the plant against attack by undesirable microorganisms. Plant-strengthening (resistance-inducing) substances in the present context are substances capable of stimulating the defence system of plants in such a way that the treated plants, when subsequently inoculated with undesirable microorganisms, develop a high degree of resistance to these microorganisms.

Further, plant physiology effects in the context of the present disclosure comprise the following:
abiotic stress tolerance, comprising tolerance to high or low temperatures, drought tolerance and recovery after drought stress, water use efficiency (correlating to reduced water consumption), flood tolerance, ozone stress and UV tolerance, tolerance towards chemicals like heavy metals, salts, pesticides etc.

Biotic stress tolerance, comprising increased fungal resistance and increased resistance against nematodes, viruses and bacteria. In the context of the present disclosure, biotic stress tolerance preferably comprises increased fungal resistance and increased resistance against nematodes.

Increased plant vigour, comprising plant health/plant quality and seed vigour, reduced stand failure, improved appearance, increased recovery after periods of stress, improved pigmentation (e.g. chlorophyll content, stay-green effects, etc.) and improved photosynthetic efficiency.

The present disclosure accordingly provides for the use of the SCs, TCs or WGs according to the disclosure for enhancing the resistance of plants to abiotic stress factors, preferably to drought stress, especially for strengthening plant growth and/or for increasing plant yield.

The further various benefits for plants mentioned above can be combined in a known manner in component form, and generally applicable terms can be used to describe them. Such terms are, for example, the following names: phytotonic effect, resistance to stress factors, less plant stress, plant health, healthy plants, plant fitness, plant wellness, plant concept, vigor effect, stress shield, protective shield, crop health, crop health properties, crop health products, crop health management, crop health therapy, plant health, plant health properties, plant health products, plant health management, plant health therapy, greening effect or regreening effect, freshness, or other terms with which a person skilled in the art is entirely familiar.

The disclosure further includes a method for treating seed.

In the text which follows, SCs, TCs or WGs according to the disclosure are referred to collectively as formulations according to the disclosure.

A further aspect of the present disclosure relates in particular to seeds (dormant, primed, pregerminated or even with emerged roots and leaves) treated with the formulations according to the disclosure. The seeds are used in methods for protection of seeds and emerged plants from the seeds from phytopathogenic harmful fungi. In these methods, seed treated with formulations according to the disclosure is used.

Formulations according to the disclosure are also suitable for the treatment of seeds and young seedlings. A large part of the damage to crop plants caused by harmful organisms is triggered by the infection of the seeds before sowing or after germination of the plant. This phase is particularly critical since the roots and shoots of the growing plant are particularly sensitive, and even small damage may result in the death of the plant. Accordingly, there is great interest in protecting the seed and the germinating plant by using appropriate compositions.

It is also desirable to optimize the amount of the active ingredient used so as to provide the best possible protection for the seeds, the germinating plants and emerged seedlings from attack by phytopathogenic fungi, but without damaging the plants themselves by the active ingredient used. In particular, methods for the treatment of seed should also take into consideration the intrinsic phenotypes of transgenic plants in order to achieve optimum protection of the seed and the germinating plant with a minimum of crop protection compositions being employed.

The present disclosure therefore also relates to a method for protecting seeds, germinating plants and emerged seedlings against attack by animal pests and/or phytopathogenic harmful microorganisms by treating the seeds with a formulation according to the disclosure. The disclosure also relates to the use of the formulation according to the disclosure for treating seeds for protecting the seeds, the germinating plants and emerged seedlings against animal pests and/or phytopathogenic microorganisms. The disclosure further relates to seed which has been treated with a formulation according to the disclosure for protection from animal pests and/or phytopathogenic microorganisms.

One of the advantages of the present disclosure is that the treatment of the seeds with these formulations not only protects the seed itself, but also the resulting plants after emergence, from animal pests and/or phytopathogenic harmful microorganisms. In this way, the immediate treatment of the crop at the time of sowing or shortly thereafter protects plants as well as seed treatment prior to sowing. It is likewise considered to be advantageous that the formulations according to the disclosure can be used especially also for transgenic seed, in which case the plant which grows from this seed is capable of expressing a protein which acts against pests, herbicidal damage or abiotic stress. The treatment of such seeds with formulations according to the disclosure, for example an insecticidal protein, can result in control of certain pests. Surprisingly, a further synergistic effect can be observed in this case, which additionally increases the effectiveness for protection against attack by pests, microorganisms, weeds or abiotic stress.

The formulations according to the disclosure are suitable for protection of seed of any plant variety which is used in agriculture, in the greenhouse, in forests or in horticulture. More particularly, the seed is that of cereals (such as wheat, barley, rye, millet/sorghum and oats), oilseed rape, maize, cotton, soya, rice, potatoes, sunflower, beans, coffee, beet (e.g. sugar beet and fodder beet), peanut, vegetables (such as tomato, cucumber, onions and lettuce), lawns and ornamental plants. Of particular significance is the treatment of the seed of wheat, soya, oilseed rape, maize and rice. Particular preference is given to wheat.

As also described below, the treatment of transgenic seed with the formulations according to the disclosure is of particular significance. This refers to the seed of plants containing at least one heterologous gene which allows the expression of a polypeptide or protein, e.g. having insecticidal properties. These heterologous genes in transgenic seeds may originate, for example, from microorganisms of the species Bacillus, Rhizobium, Pseudomonas, Serratia, Trichoderma, Clavibacter, Glomus or Gliocladium. These heterologous genes preferably originate from Bacillus sp., in which case the gene product is effective against the European corn borer and/or the Western corn rootworm. Particularly preferably, the heterologous genes originate from Bacillus thuringiensis.

In the context of the present disclosure, the formulation according to the disclosure is applied to seeds either alone or in a suitable formulation. Preferably, the seed is treated in a state in which it is sufficiently stable for no damage to occur in the course of treatment. In general, seeds can be treated at any time between harvest and some time after sowing. It is customary to use seed which has been separated from the plant and freed from cobs, shells, stalks, coats, hairs or the flesh of the fruits. For example, it is possible to use seed which has been harvested, cleaned and dried down to a moisture content of less than 15% by weight. Alternatively, it is also possible to use seed which, after drying, for example, has been treated with water and then dried again, or seeds just after priming, or seeds stored in primed conditions or as pre-germinated seeds, or seeds sown on nursery trays, tapes or paper.

The formulations according to the disclosure can be used to treat a wide variety of different kinds of seed, either directly or after prior dilution with water. For instance, the concentrates or the preparations obtainable therefrom by dilution with water can be used to dress the seed of cereals, such as wheat, barley, rye, oats, and triticale, and also seeds of maize, soya, rice, oilseed rape, peas, beans, cotton, sunflowers, and beets, or else a wide variety of different vegetable seeds. The formulations according to the disclosure, or the dilute preparations thereof, can also be used for seeds of transgenic plants. In this case, additional synergistic effects may also occur in interaction with the substances formed by expression.

For treatment of seeds with the formulations according to the disclosure, or the preparations prepared therefrom by adding water, all mixing units usable customarily for on-seed applications are useful. Specifically, the procedure in on-seed applications is to place the seeds into a mixer, to add the particular desired amount of the formulations, either as such or after prior dilution with water, and to mix everything until all applied formulations are distributed homogeneously on the seeds. If appropriate, this is followed by a drying operation.

The application rate of the formulations according to the disclosure can be varied within a relatively wide range. It is guided by the particular content of the active ingredients in the formulations and by the seeds. The application rates of each single active ingredient is generally between 0.001 and 15 g per kilogram of seed, preferably between 0.01 and 5 g per kilogram of seed.

A further preferred embodiment is the use of the formulations according to the disclosure for seed treatment.

The disclosure is illustrated in detail by the examples, without being limited thereby.

### EXAMPLES

### Feedstocks Used:

The terms used in the examples below have the following meanings:

| | |
|---|---|
| mefenpyr-diethyl | diethyl (RS)-1-(2,4-dichlorophenyl)- |
| | 5-methyl-2-pyrazoline-3,5- |
| | dicarboxylate, (Bayer CropScience AG), |
| | melting range 50-55° C. |
| flufenacet | 4′-fluoro-N-isopropyl-2-(5- |
| | trifluoromethyl-1,3,4-thiadiazol-2- |
| | yloxy)acetanilide (Bayer CropScience AG) |
| iodosulfuron-methyl | ({[5-iodo-2-(methoxycarbonyl)phenyl]sul- |
| | phonyl}carbamoyl)(4-methoxy- |
| | 6-methyl-1,3,5-triazin-2-yl)azanide |
| | (Bayer CropScience AG) |
| mesosulfuron-methyl | methyl 2-[(4,6-dimethoxypyrimidin- |
| | 2-ylcarbamoyl)sulphamoyl]-α- |
| | (methanesulphonamido)-p-toluate |
| | (Bayer CropScience AG) |
| diflufenican | 2′,4′-difluoro-2-(α,α,α-trifluoro-m- |
| | tolyloxy)nicotinanilide (Bayer |
| | CropScience AG) |
| cloquintocet-mexyl | (RS)-1-methylhexyl (5-chloroquinolin-8- |
| | yloxy)acetate, melting range 60-70° C. |
| halauxifen-methyl | methyl 4-amino-3-chloro-6-(4-chloro-2-fluoro- |
| | 3-methoxyphenyl)pyridine-2-carboxylate |
| | (CAS Number: 943831-98-9) |
| Morwet ® D-425 | naphthalenesulphonic acid/formaldehyde |
| | condensate, sodium salt (Akzo |
| | Nobel) |
| Morwet ® IP | diisopropyl naphthalenesulphonate, |
| | sodium salt (Akzo Nobel) |
| Pluronic ® PE 10500 | propylene oxide-ethylene oxide |
| | (PO-EO) block polymer (BASF) |
| citric acid | polybasic organic acid |
| Rhodopol ® 23 | xanthan derivative (Solvay) |
| Silcolapse ® 411 | silicone defoamer (Solvay) |
| Silfoam ® SE 2 | silicone defoamer (Wacker) |
| glycerol | antifreeze |
| Proxel ® GXL | preservative (biocide, Proxel) |
| Kaolin TEC1 | aluminium hydrosilicate |
| Sipernat ® 22S | precipitated silica |
| Sokalan ® K30 | polyvinylpyrrolidone, nonionic dispersant |
| Solvesso 200 ND | mineral oil, ExxonMobil, naphthalene-free |
| Calsogen ® 4814 | calcium dodecylbenzolsulphonate in |
| | 2-ethylhexanol (about 40%), Clariant |
| Emulsogen ® 3510 | nonionic surfactant, n-butyl-PO-EO |
| | block oxalkylate, Clariant |

### Test and Storage Methods:

All tests were conducted by CIPAC methods that are customary in crop protection (CIPAC=Collaborative International Pesticides Analytical Council; www.cipac.org). Long-term storage was conducted according to CIPAC MT 46.3 at 40° C. for a storage time of 8 weeks. The terms used hereinafter have the following meanings: Unless stated otherwise, testing is conducted in a 1% solution in water (CIPAC D, water hardness 342 ppm) at 23° C.
0TW=test result after zero days of storage;
8W40=test result of the accelerated storage test (8 weeks at 40° C.) to test the long-term stability of a formulation product;
Suspendability=active ingredient distribution in a 1% aqueous solution (100%=fully homogeneously distributed, 0%=fully sedimented); values <100% lead to inhomogeneous product distribution at application; according to international standards, formulation products must have values of >60%;
Suspendability 8W40=value after storage at 40° C. for 8 weeks;
D90=active ingredient particle size (laser scattering, 90% of all volume particles);
D90 8W40=active ingredient particle size after storage test (8 weeks at 40° C.); an increase in the values indicates crystal growth, with an increase by a factor of 2 usually still being acceptable; more than a factor of 4 is unacceptable;
Sediment=values >10% indicate significant sediment formation.
Sediment can be shaken up=yes for acceptable; no for unusable formulation products, since the active ingredients can no longer be converted to a spray liquor;
Wet screening=measure for possible filter blockages on spray application; values >0.1% on 150 μm screen and >0.2% on 45 μm screen (each based on the amount of formulation employed) are unacceptable.

### Production of an Aqueous Suspension Concentrate B:

For production of the examples cited in Table 1, water is initially charged at room temperature. Subsequently, while stirring, a) (and any further active ingredients e) and the further components b), c) and f) are added (in no particular sequence). a) is added warm (65° C. in the case of mefenpyr-diethyl or 80° C. in the case of cloquintocet-mexyl), and the mixture is stirred for 2 to 24 h until crystals form. The mixture is then subjected to wet grinding, for example in a bead mill. Finally, the organic thickener (component d1) is added.

In an alternative variant, rather than water at room temperature, water at 5° C. is used. The vessel is also cooled down to 5° C. Preliminary comminution is effected with a colloid mill. It was thus possible to achieve crystallization within half an hour. This is followed by wet grinding, for example by means of a bead mill.

TABLE 1
Figures are in percent by weight, % by weight

| | | Example No. | | | | | |
|---|---|---|---|---|---|---|---|
| Component | | 1 | 2 | 3 | C3 | C4 | C5 |
| a | mefenpyr- | 1.15 | | 27.27 | 1.15 | 27.27 | 27.27 |
| | diethyl | | | | | | |
| a | cloquintocet- | | 1.15 | | | | |
| | mexyl | | | | | | |
| e | diflufenican | 15.3 | 15.3 | | 15.3 | | |
| e | halauxifen- | 1.15 | 1.15 | | 1.15 | | |
| | methyl | | | | | | |
| e | flufenacet | 25.4 | 25.4 | | 25.4 | | |
| b1 | Morwet ® D- | 1.0 | 1.0 | 1.0 | 1.0 | 1.0 | 1.0 |
| | 425 | | | | | | |
| b2 | Pluronic ®PE | 5 | 5 | 5 | 5 | 5 | 5 |
| | 10500 | | | | | | |
| f | citric acid | 0.1 | 0.1 | 0.1 | 0.1 | 0.1 | 0.1 |
| c1 | Aerosil ® 200 | 0.5 | 0.5 | 0.5 | | 0 | 0.5 |
| d | Rhodopol ® 23 | 0.2 | 0.2 | 0.2 | 0.2 | 0.2 | 0 |
| f | Silcolapse ® | 0.5 | 0.5 | 0.5 | 0.5 | 0.5 | 0.5 |
| | 411 | | | | | | |
| f | glycerol | 5 | 5 | 5 | 5 | 5 | 5 |
| f | Proxel ® GXL | 0.18 | 0.18 | 0.18 | 0.18 | 0.18 | 0.18 |

| | | | | | | |
|---|---|---|---|---|---|---|
| Water | 44.72 | 44.72 | 59.25 | 45.22 | 58.75 | 58.45 |
| Total: | 100 | 100 | 100 | 100 | 100 | 100 |

### COMPARATIVE EXAMPLES

In C3 compared to 1 and in C4 compared to 3, c1) is missing in each case. An amorphous mefenpyr-diethyl forms in the formulations and cannot be processed any further. The formulations are not storage-stable and had to be discarded. In C5 without the organic thickener d1), the result was likewise storage-unstable products which were discarded.

### Stability of the Aqueous Dispersion:

The dispersions according to the disclosure from the examples have excellent storage stability. They are stable without any noticeable change at room temperature for at least 2 years and at 40° C. for at least 3 months.

TABLE 2
Storage stability and further formulation properties
of suspension concentrates 1-3:

| | CIPAC | | | |
|---|---|---|---|---|
| | test | Examples | | |
| Test method | standard | 1 | 2 | 3 |
| Chemical | In-house | no | no | no |
| degradation of the | analytical | | | |
| active ingredient | method | | | |
| 8W40 | | | | |
| Suspendability | MT 184 | 95 | 96 | 100 |
| 0TW % | | | | |
| Suspendability | MT 184 | 75 | 85 | 95 |
| 8W40 % | | | | |
| D90 in μm 0TW | MT 187 | 4 | 7 | 4 |
| D90 in μm | MT 187 | 9 | 10 | 8 |
| 8W40 | | | | |
| Sediment, 8W40 | MT 148 | no | no | no |
| Wet screening | MT 185 | 0.02 | 0.02 | 0.02 |
| 45% | | | | |
| 8W40 | | | | |
| Wet screening | MT 185 | 0.01 | 0.01 | 0.01 |
| 150% | | | | |
| 8W40 | | | | |

All the formulations according to the disclosure exhibit very good storage stability. It was not possible to identify any amorphous active ingredient under the microscope.

### Production of an Concentrate A)

For production of Examples 4-6 and C2 cited in Table 3, water is initially charged at room temperature. While stirring, the active ingredients e are then added (in the case of iodosulfuron, reaction is effected with NaOH (32%) to pH 8). b1), b2), c1), c2) and f) are added. Component a) is added warm (65° C. in the case of mefenpyr-diethyl), and the mixture is stirred for 2 to 24 h until crystals form. This is followed by wet grinding, for example by means of a bead mill.

### Production of a Part-Concentrate

For production of Example C1 cited in Table 3, water is initially charged at room temperature. While stirring, the active ingredients e) are then added (in the case of iodosulfuron, reaction is effected with NaOH (32%) to pH 8). b1), b2), c1), c2) and f) are added. Component a) is then dissolved in Solvesso® 200 ND and added as a solution. This is followed by wet grinding, for example by means of a bead mill. This forms a suspoemulsion composed of dispersed solids e) and emulsified a).

The TC slurries according to the disclosure thus obtained from Examples 4 to 6 and Example C1 are processed further to give the WG. Fluidized bed drying is effected according to the prior art. Examples 4-6 are free of organic solvents; C1 still contains 16% by weight of Solvesso® 200 ND.

TABLE 3
Technical concentrates: (figures are in percent by weight, % by weight)

| Component | | 4 | 5 | 6 | C1 |
|---|---|---|---|---|---|
| a | mefenpyr- | 6.25 | 6.25 | 6.25 | 6.25 |
| | diethyl | | | | |
| e | iodosulfuron- | 1.2 | 1.2 | 1.2 | 1.2 |
| | methyl | | | | |
| e | mesosulfuron- | 3.59 | 3.59 | 3.59 | 3.59 |
| | methyl | | | | |
| b1 | Morwet ® D- | 12.5 | 12.5 | 12.5 | 12.5 |
| | 425 | | | | |
| b1 | Morwet ® IP | 2.5 | 2.5 | 2.5 | 2.5 |
| f | NaOH (32%) | 1.19 | 1.19 | 1.19 | 1.19 |
| c1 | Aerosil ® 200 | | 5.0 | | 5.0 |
| c1 | Sipernat ® 22S | 5.0 | | 5.0 | |
| c2 | Kaolin ® TEC1 | 15.75 | 15.75 | | 4.5 |
| c2 | CaCO3 | | | 15.75 | |
| b2 | Sokalan ® K 30 | 1.0 | 1.0 | 1.0 | 1.0 |
| f | Silfoam ® SE 2 | 2.0 | 2.0 | 2.0 | 2.0 |
| f | Calsogen ® | | | | 1.62 |
| | 4814 | | | | |
| f | Emulsogen ® | | | | 1.39 |
| | 3510 | | | | |

| | | | | |
|---|---|---|---|---|
| Water | 49.02 | 49.02 | 49.02 | 49.02 |
| Solvesso ® 200 ND | | | | 8.25 |
| Total: | 100 | 100 | 100 | 100 |

### Stability of the WGs:

The examples of the water-dispersible granules (4WG-6WG and C1 WG) produced from the technical concentrates 4-6 and C1 have excellent storage stability. They are stable without any noticeable change at room temperature for at least 2 years and at 40° C. for at least 3 months. Comparative Example C₁ WG contains the unwanted Solvesso® 200 ND.

TABLE 4
Storage stability and further formulation properties

| | CIPAC | | | | |
|---|---|---|---|---|---|
| | test | Examples | | | |
| Test method | standard | 4 WG | 5 WG | 6 WG | C1 WG |
| Chemical | In-house | no | no | no | no |
| degradation of | analytical | | | | |
| the active | method | | | | |
| ingredient | | | | | |
| 8W40 | | | | | |
| Suspendability | MT 184 | 71 | 56 | 79 | 93 |
| 0TW in % | | | | | |
| Suspendability | MT 184 | constant | constant | constant | constant |
| 8W40 in % | | | | | |

1. A process for producing an aqueous, solvent-free formulation, the process comprising:
melting an active agrochemical ingredient a) to form a melt;
providing an aqueous solution comprising an ionic dispersant b1), a carrier material c1), and a filler c2), wherein the aqueous solution does not contain the active agrochemical ingredient a);
adding the melt to the aqueous solution not containing the active agrochemical ingredient a) at a temperature between 0° C. and 40° C. while stirring to form a mixture; and
crystallizing the active agrochemical ingredient a), wherein crystallizing the active ingredient comprises cooling the mixture below the melting point of the active agrochemical ingredient a) for 5 minutes to 24 hours;
wherein the active agrochemical ingredient a) has a melting temperature between 50° C. and 80° C.,
wherein the active agrochemical ingredient a) comprises mefenpyr-diethyl; and
wherein c1) is a silica.

2. A process for producing an aqueous, solvent-free formulation, the process comprising:
melting an active agrochemical ingredient a) to form a melt;
providing an aqueous solution comprising an ionic dispersant b1), a carrier material c1), and a filler c2), wherein the aqueous solution does not contain the active agrochemical ingredient a);
adding the melt to the aqueous solution not containing the active agrochemical ingredient a) at a temperature between 0° C. and 40° C. while stirring to form a mixture;
crystallizing the active agrochemical ingredient a), wherein crystallizing the active ingredient comprises cooling the mixture below the melting point of the active agrochemical ingredient a) for 5 minutes to 24 hours; and
griding the crystallized active agrochemical ingredient a) into particles, wherein at least 50% of the particles having a size of 1 to 5 μm (d50, volume particles);
wherein the active agrochemical ingredient a) has a melting temperature between 50° C. and 80° C.,
wherein the active agrochemical ingredient a) comprises mefenpyr-diethyl; and
wherein c1) is a silica.

3. A technical concentrate (TC) obtained by the process according to claim 2.

4. The process according to claim 2, further comprising removal of the aqueous solution.

5. A water-dispersible granule (WG) obtained by the process according to claim 4.

6. The process according to claim 1, wherein the aqueous solution further comprises a nonionic dispersant b2).

7. A water-dispersible suspension concentrate (SC) obtained by the process according to claim 6.

8. The process according to claim 1, wherein the carrier material c1) is selected from the group consisting of highly absorptive carriers having an absorption capacity of at least 200 g of di butyl phthalate per 100 g of carrier material.

9. The solvent-free, water-dispersible technical concentrate (TC) according to claim 3, further comprising an active ingredient e) selected from the group consisting of a sulphonylurea, an HPPD (4-hydroxyphenylpyruvate dioxygenase) inhibitor, an ALS (acetolactate synthase) inhibitor and a typical pigment bleacher.

10. The solvent-free, water-dispersible technical concentrate (TC) according to claim 9, wherein the active ingredient e) is selected from the group consisting of mesosulfuron methyl, iodosulfuron-methyl-sodium or -acid, amidosulfuron, thiencarbazone-methyl and difluence.

11. The solvent-free, water-dispersible suspension concentrate (SC) according to claim 7, further comprising an active ingredient e) selected from the group consisting of an auxin, an inhibitor of pigment synthesis, a DOXP synthase inhibitor and a VLCFA inhibitor.

12. The solvent-free, water-dispersible suspension concentrate (SC) according to claim 11, wherein the active ingredient e) is selected from the group consisting of halauxifen-methyl, diflufenican, clomazone, isoxazolidinone, 2-[(2,4-dichlorophenyl)methyl]-4,4-dimethyl-3-isoxazolidinone (CAS Number 81777-95-9) and flufenacet.

13. A herbicidal composition comprising a formulation obtained by the process according to claim 1 and water.

14. A water-dispersible suspension concentrate (SC) according to claim 7 or a composition thereof for controlling unwanted plant growth.

15. A technical concentrate (TC) according to claim 3 or a composition thereof for controlling unwanted plant growth.

16. A method of controlling unwanted plant growth, comprising applying a water-dispersible suspension concentrate (SC) according to claim 7 or a composition thereof to weeds, plant parts, plant seeds and/or an area in which plants grow.

17. A seed that has been treated with a water-dispersible suspension concentrate (SC) according to claim 9 for protection against one or more animal pests and/or phytopathogenic microorganisms.

18. The solvent-free, water-dispersible technical concentrate (TC) according to claim 9, further comprising one or more nonionic emulsifiers b2).

19. The solvent-free, water-dispersible suspension concentrate (SC) according to claim 7, further comprising at least one or more than one thickener d).
